(19) United States
(12) Patent Application Publication
(10) Pub. No.: US 2001/0034268 A1
(43) Pub. Date: Oct. 25, 2001

(54) User interface for interactive wagering systems

(76) Inventors: Jay D. Thomas, Denver, CO (US); Masood Garahi, Superior, CO (US); Wade W. Turner, Louisville, CO (US); Eric F. Stimmel, Louisville, CO (US)

Correspondence Address: FISH & NEAVE, 1251 AVENUE OF THE AMERICAS, 50TH FLOOR, NEW YORK, NY, 10020-1105, US

(21) Appl. No.: 09/796,097

(22) Filed: Feb. 28, 2001

Related U.S. Application Data
(60) Provisional application No. 60/186,261, filed on Mar. 1, 2000.

(51) Int. Cl. A63F 13/00

(52) U.S. Cl. 463/40

(57) ABSTRACT

An interactive wagering application is provided that assists users in finding races on which the users desire to wager on and that assists users in placing wagers on the desired races. The application may provide a search feature that allows the user to search for races based on user inputted search criteria such as favorite jockey, trainer, runner, or any suitable combination thereof. The application may also provide a next hour feature that searches for upcoming races that start within a certain time period. The application may also display an interactive overlay that contains information to assist users in creating a wager. The interactive overlay may be displayed when a user highlights or points to information. The interactive overlay may contain, for example, an estimated current payout for a specific wager amount, the total amount of the wager, the weather conditions at a racetrack, or any other suitable information. The application may be implemented using platforms based on set-top boxes, personal computers, handheld computing devices, cellular telephones, or other suitable devices.

This application claims the benefit of U.S. provisional application No. 60/186,261, filed Mar. 1, 2000, which is hereby incorporated by reference herein in its entirety.

### Background of the Invention

This invention relates to interactive wagering, and more particularly, to interactive wagering applications that assist users in finding races on which the users desire to wager on and that assist users in placing wagers on desired races.

Wagering is a popular leisure activity. For example, many racing fans wager on events such as horse, dog, and harness racing. However, it may be inconvenient to attend racing events in person. Not all racing fans have sufficient time to visit racetracks as often as they would like and some fans have difficulties in obtaining suitable transportation to the track. Off-track betting establishments are available for fans who cannot attend racing events in person, but fans must still travel to the off-track betting establishments.

As a result, systems have been developed in which fans may place off-track wagers using personal computers connected to the Internet, telephones, and set-top boxes. Regardless of the type of platform that is used to provide interactive wagering to the user, the process of creating a wager typically involves selecting a racetrack of interest, selecting a race at the racetrack, selecting a wager type, selecting a runner or runners for the wager, and selecting the wager amount. Because many races are run each day, it can become difficult for users to locate races or runners of particular interest.

In view of the foregoing, it is an object of the present invention to provide an improved interactive wagering system.

It is a more particular object of the present invention to provide an improved interactive wagering system that allows the user to search for a favorite jockey, trainer, or runner, or any suitable combination thereof in races that are available to be wagered on.

It is also an object of the invention to provide an improved interactive wagering system that allows the user to search for upcoming races that are available to be wagered on and that are to be run within the next hour or other time period.

It is a further object of the invention to provide an improved interactive wagering system that provides additional information to the user in the form of interactive overlays.

### SUMMARY OF THE INVENTION

These and other objects of the invention are accomplished in accordance with the principles of the present invention by providing an interactive wagering system in which an interactive wagering application allows users to search for a favorite jockey, trainer, or runner. This search feature may be available to the user in the first step in the process of creating a wager. This step is typically selecting a racetrack. When a user searches for specific criterion such as jockey, trainer, or runner, the interactive wagering application may display all of the available races and their corresponding racetracks that match the specific criterion. In addition, a user may enter and search for two or more criterion simultaneously. The interactive wagering application may, in response to a search for two or more criterion, display races and their corresponding racetracks that match each criterion and that match the combination or combinations of the criterion. The race and racetrack information is displayed according to the criterion that are matched. When a user finds a race of interest, the user may select that race. The interactive wagering application may then display additional information on the race and provide the user with an opportunity to place a wager on the race. If the user decides to place a wager on the race, the interactive wagering application may display a screen that requests a wager type. This allows a user to efficiently search through the many available races to find a race or races of interest. This may also allow a user to advance directly to selecting a wager type in the process of creating a wager, thereby bypassing selecting a track and race.

The interactive wagering application may also provide users with the opportunity to search for upcoming races that will be run in the next hour or other suitable time period. This feature may be available to the user in the first step in the process of creating a wager. Typically, a user is able to access race information for races that are available to be wagered on for the current day. A user may, however, be interested in placing a wager on a race that will be run shortly. Therefore, by selecting the next hour feature, the user may be presented with upcoming races that will be run in the next hour. The displayed races may be ordered based on their post time. If the user is interested in a given race, the wagering application may display additional information on that race and may provide the user with an opportunity to place a wager on that race. If the user decides to place a wager on the race, the interactive wagering application may display a screen that requests a wager type. This feature, therefore, allows a user to quickly find races that will be run shortly. This may also allow a user to advance directly to selecting a wager type in the process of creating a wager, thereby bypassing selecting a track and race.

The interactive wagering application may also provide the user with additional information in the form of interactive overlays or rollovers. The additional information in the interactive overlay may, for example, assist the user in creating a wager. In some embodiments of the present invention, when a user is making selections in the process of creating a wager, race information may be abbreviated or presented in a simpler format. The wagering application may display the interactive overlay when a user highlights or points to abbreviated information or information that is presented in a simpler format. The interactive overlay may also provide additional information in the interactive overlay to assist the user in his or her selections. For example, the interactive overlay may display jockey and trainer information, morning line odds, or current odds when a user is selecting a horse or horses for a specific wager type. In addition, when the interactive wagering application presents various wagering amounts for selection, the application may display the interactive overlay when the user highlights or points to specific wager amounts. The interactive overlay may contain the estimated current payout for the specific amount, the total amount of the wager (if the wager contains more than one bet), or other information that may be of interest to the user.

Further features of the invention, its nature and various advantages will be more apparent from the accompanying drawings and the following detailed description of an illustrative wagering system on which the interactive wagering applications may be implemented.

### BRIEF DESCRIPTION OF THE DRAWINGS

FIG. 1 is a schematic diagram of an illustrative interactive wagering system on which interactive wagering applications may be implemented in accordance with the present invention.

FIG. 2 is a schematic diagram of illustrative user equipment in accordance with the present invention.

FIG. 3 is a flow chart illustrating steps involved in creating a wager in accordance with one embodiment of the present invention.

FIGS. 4A-F show illustrative display screens for allowing a user to create a wager in accordance with one embodiment of the present invention.

FIG. 5 is a flow chart illustrating steps involved in a search feature that allows the user to search for available races based on user inputted search criteria in accordance with one embodiment of the present invention.

FIGS. 6A-D show illustrative display screens for allowing the user to search through available races for a desired jockey in accordance with one embodiment of the present invention.

FIGS. 7A-D show illustrative display screens for allowing the user to search through available races for a desired trainer in accordance with one embodiment of the present invention.

FIGS. 8A-D show illustrative display screens for allowing the user to search through available races for a desired horse in accordance with one embodiment of the present invention.

FIG. 9 is a flow chart illustrating steps involved in a next hour feature that allows the user to search for upcoming races that will be run in a certain period of time in one embodiment of the present invention.

FIGS. 10A-C show illustrative display screens for allowing the user to search for upcoming races that will be run in a certain period of time in accordance with one embodiment of the present invention.

FIG. 11 is a flow chart illustrating steps involved in displaying an interactive overlay feature in accordance with the present invention.

FIGS. 12A-B show illustrative display screens for displaying the estimated current payout in an interactive overlay in accordance with one embodiment of the present invention.

FIGS. 13A-B show illustrative display screens for displaying the full form of an abbreviation in an interactive overlay in accordance with one embodiment of the present invention.

FIGS. 14A-B show illustrative display screens for displaying the total wager amount in an interactive overlay in accordance with one embodiment of the present invention.

FIG. 15 is a diagram of an illustrative user cellular telephone equipment in accordance with the present invention.

### DETAILED DESCRIPTION OF AN THE PREFERRED EMBODIMENTS

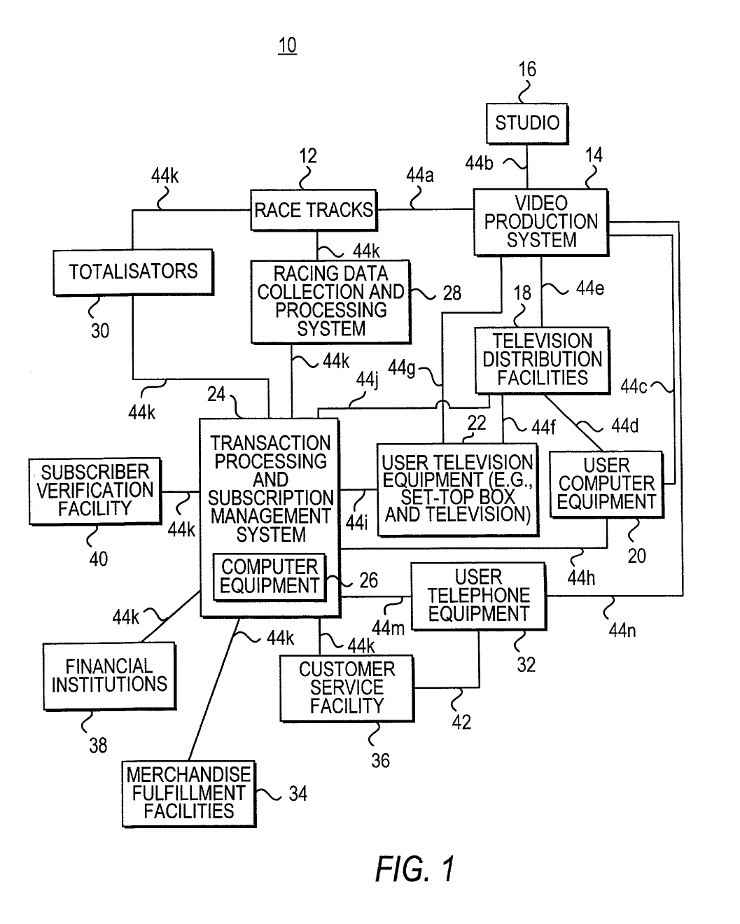

An illustrative interactive wagering system 10 in accordance with the present invention is shown in FIG. 1. Aspects of the invention apply to various different types of wagering, but are described herein primarily in the context of interactive wagering on races (e.g., horse races) for specificity and clarity.

Races may be run at racetracks 12, which may be located at various geographic locations. Races run at the racetracks may be simulcast to television viewers. For example, simulcast videos may be provided to users with satellite receivers or to off-track betting establishments via satellite.

System 10 may be used to provide an interactive wagering service to users of various user equipment. An interactive wagering application may be used to provide the wagering service. The interactive wagering application may run locally on the user equipment (e.g., on a set-top box, personal computer, cellular telephone, handheld computing device, etc.) or may run using a client-server or distributed architecture where some of the application is implemented locally on the user equipment in the form of a client process and some of the application is implemented at a remote location (e.g., on a server computer or other such equipment in the system) as a server process. These arrangements are merely illustrative. Other suitable techniques for implementing the interactive wagering application may be used if desired.

Real-time videos from racetracks 12 may also be provided to video production system 14 for distribution to users as part of a television wagering service (i.e., a wagering-related television channel or Internet-delivered service or the like). If desired, multiple simulcast videos may be provided to video production system 14 in real-time. Talent (e.g., commentators) for the television wagering service provided by the interactive wagering application may be located at studio 16. Studio 16 may provide a video feed containing commentary and the like to video production system 14. Graphic overlays for the television wagering service may be added to the service at video production system 14.

The television wagering service may use video production system 14 to combine selected video segments from desired racing simulcasts with the video feed from studio 16 and suitable graphic overlays. If desired, video production system 14 or a separate facility may be used to reformat simulcasts from racetracks 12. For example, if racetracks 12 provide simulcasts as traditional analog television channels, video production system 14 (or a separate facility) may convert these simulcasts or portions of these simulcasts into digital signals (e.g., digital video signals) or into a different number of analog signals. Digital video signals may require less bandwidth than analog video signals and may be appropriate for situations in which videos are to be transmitted over either high or low bandwidth pathways. Low bandwidth pathways may include telephone lines, the Internet, etc.

Video production system 14 may be used to provide a television wagering service that includes selected simulcast videos, video from studio 16, and graphic overlays to television distribution facilities 18 (for redistribution to user television equipment 22 and user computer equipment 20), to user computer equipment 20, and to user telephone equipment 32 (if user telephone equipment 32 has a display capable of displaying moving images). Television distribution facilities 18 may be any suitable facilities for supplying television to users, such as cable system headends, satellite systems, broadcast television systems, or other suitable systems or combinations of such systems. User computer equipment 20 may be any suitable computer equipment that supports an interactive wagering application. For example, user computer equipment 20 may be a personal computer. User computer equipment 20 may also be based on a mainframe computer, a workstation, a networked computer or computers, a laptop computer, a notebook computer, a handheld computing device such as a personal digital assistant or other small portable computer, etc.

Each of television distribution facilities 18 is typically located at a different geographic location. Users with user television equipment 22 may receive the television wagering service from an associated television distribution facility. User television equipment 22 may include, for example, a television or other suitable monitor. A television may be used to watch the television wagering service on a traditional analog television channel. User television equipment 22 may also include a digital or analog set-top box connected to a television distribution facility 16 by a cable path. A digital set-top box may be used to receive the television wagering service on a digital channel. If desired, user television equipment 22 may contain a satellite receiver, a WebTV box, a personal computer television (PC/TV), or hardware similar to such devices into which set-top box capabilities have been integrated. A recording device such as a videocassette recorder or digital recording device (e.g., a personal video recorder or digital video recorder based on hard disk drives or the like) may be used in user television equipment 22 to store videos. The recording device may be separate from or part of the other components of user television equipment 22.

User computer equipment 20 may receive the television wagering service using a video card or other video-capable equipment to receive analog or digital (e.g., moving picture experts group or MPEG) videos from a television distribution facility. User computer equipment 20 may also receive the television wagering service directly from video production system 14 using, for example, a modem link. If desired, the video for the television wagering service may be compressed (e.g., using MPEG techniques). This may be useful, for example, if the path to user computer equipment 20 is a modem connection using telephone links. If video production system 14 is only used to serve user computer equipment 20 without traditional analog television capabilities, video production system 14 may only need to supply such digitally-compressed video signals and not analog television signals.

Video clips of races and other simulcast information may be provided to users in the form of a television wagering service or by an interactive wagering service provided by the interactive wagering application. If desired, race-related videos may be provided to the user by using video production system 14 or other suitable equipment to route appropriate video clips from the simulcasts to the user in real-time. Video clips may also be stored for later viewing. For example, one or more video servers located at racetracks 12, video production system 14, television distribution facilities 18, or other suitable locations may be used to store video clips. The stored videos may then be played back in real-time or downloaded for viewing at user television equipment 22, user computer equipment 20, or user telephone equipment 32. The video clips may contain videos of races, commentary, interviews with jockeys, or any other suitable race-related information. If desired, real-time or stored videos may be provided from racetracks 12 directly to user television equipment 22, user computer equipment 20, or user telephone equipment 32 over the Internet or other suitable communications paths without involving video production system 14. Videos may also be provided by routing video signals through equipment located elsewhere in system 10. For example, videos may be routed through transaction processing and subscription management system 24.

Transaction processing and subscription management system 24 may contain computer equipment 26 and other equipment for supporting system functions such as transaction processing (e.g., handling tasks related to wagers, product purchasing, adjusting the amount of funds in user accounts based on the outcomes of wagers, video clip ordering, etc.), data distribution (e.g., for distributing racing data to the users), and subscriber management (e.g., features related to opening an account for a user, closing an account, allowing a user to add or withdraw funds from an account, changing the user's address or personal identification number, etc.). Databases within transaction processing and subscription management system 24 or associated with system 24 may be used to store racing data, wagering data and other transaction data, and subscriber data such as information on the user's current account balance, past wagering history, individual wager limits, personal identification number, billing addresses, credit card numbers, bank account numbers, social security numbers, etc. Using such databases may allow the user to access information more quickly and allows for central administration of the wagering service.

If desired, racing videos and other services may be provided using servers and other equipment located at transaction processing and subscription management system 24. For example, video clips may be provided to the user on-demand. Interactive advertisements may be provided to the user. When the user selects a desired advertisement, transaction processing and subscription management system 24 may provide additional information or other services related to the advertisement to the user.

Product ordering services may be implemented using computer equipment at transaction processing and subscriber management system 24 to handle orders and to assist in adjusting the appropriate account of the user accordingly. Orders may be fulfilled using merchandise fulfillment facilities 34. Merchandise fulfillment facilities 34 may be operated solely to provide merchandise fulfillment or may be associated with independently-operated mail-order or on-line businesses. Similar facilities may be used to allow users to order services.

Statistical racing data such as the post times for each race, jockey names, runner names and the number of races associated with each track, handicapping information (e.g., information on past performances such as the number of wins and losses for the past year, etc.), and weather conditions at various tracks may be provided by racing data collection and processing system 28. Some of the data may be collected from racetracks 12 and some may be provided by third party information sources such as Axcis Pocket Information Network, Inc. of Santa Clara, Calif. or other suitable data sources.

Racing data may also be provided from totalisators 30. Totalisators 30 are the computer systems that may be used to handle wagers made at the racetracks, made at off-track betting establishments, and made using interactive wagering system 10. Totalisators 30 generate wagering odds in real-time. Totalisators 30 generate these odds based on information on which wagers are being placed (e.g., based on information on which wagers are being placed on races at racetracks 12). Totalisators 30 are available from companies such as Amtote International, Inc. of Hunt Valley, Md. Totalisators 30 may be associated with individual racetracks 12 or groups of racetracks 12. Totalisators 30 may communicate with one another using a communication protocol known as the Intertote Track System Protocol (ITSP). This allows totalisators 30 to share wagering pools. Totalisators 30 may provide racing data including information on the current races at racetracks 12, the number of races associated with each racetrack, win, place, and show odds and pool totals for each horse or other runner, and exacta, trifecta, and quinella payoff predictions and pool totals for every possible combination of runners. Totalisators 30 may also provide current odds and other real-time racing data for other types of wagers. Totalisators 30 may provide the time until post time for each race.

Totalisators 30 may provide race results, such as the order-of-finish list for at least the first three positions and payoff values versus a standard wager amount for win, place, and show, for each runner in the finish list. Payoff values may be provided for winning complex wager types such as exacta, trifecta, quinella, pick-n (where n is the number of races involved in the pick-n wager), and daily double. The payoff values may be accompanied by a synopsis of the associated finish list.

Totalisators 30 may also provide program information of the type typically provided in printed racing programs. Such program information may include early odds, early scratches, race descriptions (including the distance of each race and the race surface—grass, dirt, artificial turf, etc.), allowed class ratings (based on a fixed ratio of external criteria), purse value (payoff to winning runner), allowed age range of runners, and the allowed number of wins and starts for each runner.

If desired, some of the information provided to transaction processing and subscription management system 24 by totalisators 30 (such as the program information or other suitable racing data) may be provided by racing data collection and processing system 28. Similarly, some of the information provided to transaction processing and subscription management system 24 by racing data collection and processing system 28 may be provided by totalisators 30. Moreover, the foregoing examples of different suitable types of racing data are merely illustrative. Any suitable data related to racing may be provided to transaction processing and subscription management system if desired.

Transaction processing and subscription management system 24 provides the racing data to users at user television equipment 22, user computer equipment 20, and user telephone equipment 32 for use in following race results and developing wagers. If desired, racing data may be provided to users using paths that do not directly involve transaction processing and subscription management system 24. For example, racing data may be provided from racing data collection and processing system 28 to user television equipment 22, user computer equipment 20, or user telephone equipment 32 using the Internet or other suitable communications paths.

User telephone equipment 32 may be a conventional telephone, a cordless telephone, a cellular telephone or other portable wireless telephone, or any other suitable telephone equipment. Users at user television equipment 22 and user computer equipment 20 may view information on the racing data on a television or other suitable monitor. Users at user telephone equipment 32 may listen to racing data using an interactive voice system. User telephone equipment 32 may be based on cellular telephones or other telephones with displays. Users may view racing data and videos displayed on such displays.

Users who wish to place wagers may establish an account at transaction processing and subscription management system 24. An account may also be established at one of totalisators 30. The user and the interactive wagering services may have their own bank accounts at financial institutions 38. A user may set up an account electronically by using user television equipment 22, user computer equipment 20, or user telephone equipment 32 to interact with the subscriber management functions of transaction processing and subscription management system 24. If desired, accounts may be established with the interactive wagering service with the assistance of customer service representatives at customer service facility 36. Customer service facility 36 may be at the same location as transaction processing and subscription management system 24, may be part of system 24, or may be located remote from system 24. Customer service representatives at customer service facility 36 may be reached by telephone. If user telephone equipment 32 is used to access the interactive wagering service, for example, user telephone equipment 32 may be used to reach the customer service representative using communications path 42. If user television equipment 22 or user computer equipment 20 is being used with the service, a telephone at the same location as that equipment may be used to reach the customer service representative.

The user's identity may be checked using social security number information or other identification information with the assistance of subscriber verification facility 40. The services of subscriber verification facility 40 are used to ensure that the user lives in a geographic area in which wagering is legal, that the user is of a legal age, and that the identification information (e.g., the user's social security number) matches the name provided by the user. If the user is using a cellular telephone or handheld computing device, the user's present physical location may be determined by determining which general part of the cellular telephone network is being accessed by the user or by using the cellular network or a handset-based location device such as a global positioning system (GPS) receiver in the body of the cellular telephone to pinpoint the user's location. This location information may be used to verify that the user is located in a geographic area where wagering is legal.

In a typical enrollment process, the user provides personal information to the interactive wagering service and provides funds with a credit card or funds from the user's bank account. The interactive wagering service sets up an account for the user at transaction processing and subscription management system 24 and directs one of totalisators 30 to set up a new account for the user at the totalisator. The totalisator is also directed to credit the user's account to reflect the amount of funds provided by the user. After the user places a wager and wins or loses, the totalisator adjusts the user's totalisator account to reflect the outcome of the wager. The totalisator may periodically inform the interactive wagering service of the adjusted balance in the user's account. This may be accomplished using any suitable technique (e.g., periodically, continuously, on-request, etc.). For example, reports may be collected periodically (e.g., once a day in an end-of-day report) and provided to the interactive wagering service to reconcile the account balances at transaction processing and subscription management system 24 with the account balances at totalisators 30.

If the user makes a balance inquiry, the inquiry may be passed to the appropriate totalisator by transaction processing and subscription management system 24. If the user is charged a fee for subscribing to the service, the service may debit the fee from the user's account at the transaction processing and subscription management system 24.

The accounts at totalisators 30 and transaction processing and subscription management system 24 are typically maintained separately, because the business entities that operate totalisators 30 and transaction processing and subscription management system 24 are independent. If desired, financial functions related to opening and maintaining user accounts and the like may be handled using computer equipment at another location such as one of financial institutions 38 or other location remote from totalisators 30 and system 24. Such financial functions may also be implemented primarily at a totalisator 30 or primarily at the transaction processing and subscription management system 24 if desired.

Users at user television equipment 22, user computer equipment 20, and user telephone equipment 32 may place wagers by providing wagering data and otherwise interacting with transaction processing and subscription management system 24. The interactive wagering service may provide a user at user television equipment 22, user computer equipment 20, or user telephone equipment 32 that has display capabilities with screens containing various racing data. For example, the user may be presented with screens that allow the user to view the current odds for horses in an upcoming race at a given track.

The service may provide the user with interactive screens containing menus and selectable options that allow the user to specify the type of wager in which the user is interested and the desired wager amount. With a set-top box arrangement, for example, the user may use a remote control or wireless keyboard to navigate the various menus and selectable options. With a personal computer, the user may use a keyboard, mouse, trackball, touch pad, or other suitable input or pointing device. With a cellular telephone with a display, the user may use buttons on the telephone. When the user has made appropriate selections to define a desired wager, the user television equipment, user computer equipment, or user telephone equipment may transmit wagering data for the wager to transaction processing and subscription management system 24.

Users with telephones may also interact with the service using an interactive voice response system located at transaction processing and subscription management system 24. The interactive voice response system may present menu options to the user in the form of audio prompts (e.g., “press 1 to select a $2 wager amount,” etc.). The user may interact with the service be pressing the corresponding buttons on a touch tone telephone. User telephone equipment 32 that is based on cellular telephones allows the user to interact with the wagering service in this way. User telephone equipment 32 that is based on cellular telephones with messaging and display capabilities also allows the user to interact visually with the interactive wagering service.

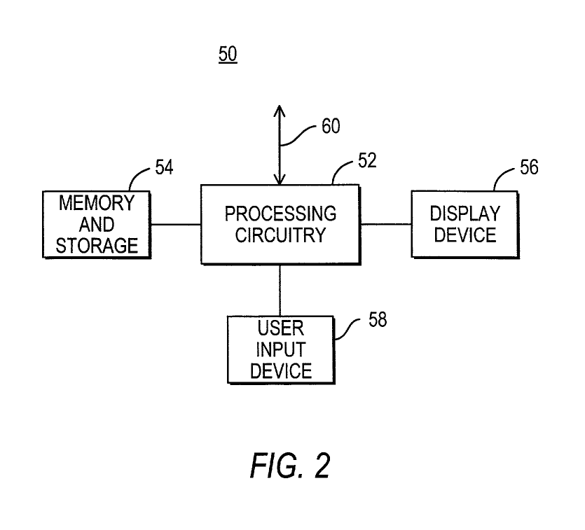

User equipment 50 of FIG. 2 shows a generalized schematic diagram of user television equipment 22, user computer equipment 20, and user telephone equipment 32 of FIG. 1. User equipment 50 may include processing circuitry 52, memory and storage 54, display device 56, and user input device 58.

Processing circuitry 52 and memory and storage 54 may allow user equipment 50 to support functions such as receiving television programming, recording videos in storage, storing information in memory, accessing interactive services such as an interactive wagering application, television wagering service, interactive television program guide, web browsing and Internet access, and other services such as home shopping, home banking, and video-on-demand services, etc. over communications path 60. Processing circuitry 52 and memory and storage 54 may be included in a set-top box, satellite receiver, a WebTV box, personal computer, laptop computer, notebook computer, cellular telephone, a handheld computing device such as a personal digital assistant, etc.

Memory and storage 54 may include a magnetic media recorder (e.g., hard disk drive or the like), memory (e.g. flash memory, EEPROM, or the like), a videocassette recorder, a digital recording device, any other suitable memory and storage device, or any suitable combination thereof. Some or all of memory and storage 54 may be located external to the device that contains processing circuitry 52.

Communications path 60 may allow user equipment 50 to communication with the interactive wagering system through communications paths 42, 44c, 44d, 44f-i, 44m, and 44n of FIG. 1, the Internet or other suitable communications paths.

The user may interact with control circuitry 52 using any suitable user input device 58, such as a remote control, keyboard, wireless keyboard, keypad, remote with a touch pad, handheld computer, mouse, trackball, touch pad, handwriting recognition system or any other suitable input device. User input device 58 may allow the user to submit user inputs to control processing circuitry 52 through a hard-wired, wireless, or infrared link. User input device 58 may also allow the user to control display device 56.

Display device 56 may be a television, monitor, liquid crystal display (black and white or color), a plasma display, a light-emitting diode display, an active matrix display, or other suitable display device.

The components of system 10 may be interconnected using various communications paths 44. Communications paths 44 may include satellite paths, coaxial cable paths, fiber-optic paths, twisted pair paths, other wire or cable-based links, wireless paths through free space, or any other suitable paths or combination of such paths. Communications over paths 44 may involve analog transmissions, digital transmissions, wireless transmissions, microwave transmissions, radio-frequency transmissions, optical transmissions, audio transmissions, or any other suitable type of transmissions or combination of such transmissions. Communications may involve Internet transmissions, private network transmissions, packet-based transmissions, television channel transmissions, transmissions in the vertical blanking interval of a television channel or on a television sideband, MPEG transmissions, etc. Communications may involve wireless pager or other messaging transmissions. Communications paths 44 may include cable connected to cable modems, digital subscriber lines, integrated services digital network (ISDN) lines, or any other suitable paths. Examples of suitable communications paths are described below. Those examples are, however, merely illustrative. Any of the communications path arrangements described above or other suitable arrangements may be used if desired.

Communications paths that carry video and particularly uncompressed analog video or lightly-compressed or full-screen digital video generally use more bandwidth than communications paths that carry only data or that carry partial-screen digital video. For example, if it is desired to transmit high-quality simulcasts of races from racetracks 12 to video production system 14, analog or digital videos may be transmitted from racetracks 12 to video production system 14 over path 44a using satellite links. Video may be transmitted from studio 16 to video production system 14 over path 44b using a satellite link or a high-speed terrestrial path such as a fiber-optic path. Studio 16 may also be located at the same site as video production system 14, thereby avoiding the need for a long-haul transmission path. Videos may be transmitted from video production system 14 to user computer equipment 20 over path 44c using a modem link (using, for example, a digital subscriber line, a telephone network link, a wireless link, etc.) The modem link may be made over a private network.

A user with a cable modem may connect a personal computer or other such user computer equipment 20 to an associated cable system headend using path 44d. (The headend in such an arrangement would be one of the television distribution facilities 18 shown in FIG. 1.) The user may then receive videos from the headend via cable modem. Videos may be provided to the headend over path 44e using a network link, fiber optic links, cable links, microwave links, satellite links, etc. A user with a set-top box or similar device (shown in FIG. 1 as user television equipment 22) may also receive videos from a cable system headend using a cable modem or other such communications device over path 44f. In addition, a user with user television equipment may receive videos over the Internet or a private network using a telephone-based modem or other such communications device using path 44g. In a system with distributed processing, interactive wagering services may be provided using a television distribution facility 18 that includes equipment that supplements or replaces at least some of the equipment at transaction processing and subscription management system 24.

If desired, user television equipment 22 or user computer equipment 20 may receive analog or digital videos from an associated television distribution facility over the communications paths normally used to distribute television programming (e.g., paths 44f and 44d). For example, videos may be received as part of a dedicated interactive wagering service television channel. If videos are provided as digital signals (e.g., MPEG signals), 10 or more digital videos may be carried on a single analog channel (or one digital video may be carried on one-tenth of the bandwidth of an analog channel). If the videos are not full-screen videos, even more videos may be simultaneously provided without a loss of image quality.

Racing videos may be provided to user telephone equipment 32 over a partially-wireless telephone Internet link or other telephone link using path 44n.

If desired, racing data may accompany the racing videos along any of these paths. Moreover, racing videos may be provided by routing them directly from racetracks 12 to user television equipment 22, user computer equipment 20 (e.g., over the Internet or a private network, etc.), or user telephone equipment 32. Racing videos may also be provided by routing them through transaction processing and subscription management system 24. If a cellular telephone or portable computing device has sufficient display capabilities to support moving images, racing videos may be displayed. Such videos may be provided using any suitable path, such as a direct path from racetracks 12, a path through video production system 14 or other suitable video processing equipment, through a hub such as transaction processing and subscription management system 24, etc. Racing videos may be provided in real-time or may be recorded for later distribution. Videos that are not provided in real-time may be downloaded by user television equipment 22, user computer equipment 20, a cellular telephone, or other suitable user equipment at a lower data rate than would otherwise be required and may be downloaded in the background if desired. Such videos may also be provided to the user at real-time video rates for direct viewing by the user.

Racing data and other information related to the interactive wagering service may be provided to users over paths connected to transaction processing and subscription management system 24. For example, racing data and other data for the service may be provided to user computer equipment 20 over path 44h using a modem link. Path 44h may be a private network path or an Internet path. Path 44h may use telephone lines, digital subscriber lines, ISDN lines, wireless data paths, or any other suitable type of communications links. User television equipment 22 may receive data for the wagering service over communications path 44i, which may be a telephone line, digital subscriber line, ISDN line, or other suitable type of communications path and which may use a private network path or an Internet path, etc.

Data for the wagering service may be provided to users of the interactive wagering application via communications path 44j and paths 44f and 44d. Communications path 44j may be provided over a private network, using the public telephone network, using satellite links, or any other suitable type of links. Data from paths such as path 44j may be routed to paths such as paths 44f and 44d directly by associated television distribution facilities 18, or may be buffered at television distribution facilities 18 if desired. Paths 44f and 44d may include coaxial cable and use of paths 44f and 44d may involve the use of cable modems or the like. If data is provided over path 44j and path 44f or path 44d using an Internet protocol, a web browser or similar software running on user television equipment 22 or user computer equipment 20 may be used to access the data. Such software may be integrated into the interactive wagering application or may be used separately. Software may also be used to view videos and may be used on other platforms (e.g., advanced cellular telephones) if desired.

The communications paths 44k that are used to connect various other components of the system typically do not carry high-bandwidth video signals. Accordingly, paths 44k may be telephone-like paths that are part of the Internet or a private network. Such paths and various other paths 44 may be dedicated connections for security, reliability, and economy.

User telephone equipment 32 may receive information for the wagering service via path 44m. If user telephone equipment 32 is a standard (non-cellular) telephone, such information may be in the form of audio prompts (“press 1 to place a wager”) and audio racing data (“the current win odds for horse 2 are 5-1”). Transaction data processing and subscription management system 24 may contain interactive voice response equipment that provides such information to the user and that responds to touch-tone signals from the user when the user responds to prompts by pressing buttons on the user's telephone.

If user telephone equipment is a cellular telephone, racing data and other information for the interactive wagering service may be provided to the user by using a cellular wireless connection as part of path 44m. Users with cellular telephones may be provided with audio prompts using an interactive voice response system located at transaction processing and subscription management system 24 to which the users may respond by pressing cellular telephone buttons to generate touch-tone signals.

Racing data and other information for the interactive wagering service may be provided to cellular telephones in the form of alphanumeric messages. Such messages may be transmitted to the user by using paging or other alphanumeric messaging formats or any other suitable data communications scheme. If desired, data may be provided to the cellular telephones over the voice channel and decoded by the cellular telephone using modem circuitry or other suitable circuitry. Data may also be provided using any other suitable cellular or wireless path. Regardless of the way in which racing data and other information for the interactive wagering service are provided to the cellular telephone, such information may be provided to the user by displaying it on the cellular telephone display screen or by presenting it in audible form through the speaker of the cellular telephone.

Racing data and other interactive wagering service information for the users may be provided in one or more continuous data streams, may be provided periodically (e.g., once per hour or once per day), or may be provided using a client-server arrangement in which data is requested by a client processor (e.g., user television equipment 22, user computer equipment 20, user telephone equipment 32, or any other such equipment) from a server (e.g., a server implemented using computer equipment 26 at transaction processing and subscription management system 24 or computer equipment at another suitable location. Videos may also be provided using any of these techniques.

A return communications path between the user and the interactive wagering service may be used to allow the user to place wagers and otherwise interact with the interactive wagering service. For example, a user with a standard telephone or a cellular telephone may interact with the service by pressing touch-tone keys on the telephone in response to audio prompts provided by an interactive voice response system at transaction processing and subscription management system 24. If desired, users may call customer service representatives at customer service facility 36 and place wagers with manual assistance. The user of a cellular telephone may interact with the wagering service by selecting menu options and otherwise interacting with information displayed on the cellular telephone. When a selection is made, software implemented on the telephone may be used to assist the user in transmitting appropriate data (e.g., wagering data) to the wagering service. Such data may be transmitted using any suitable technique. For example, data may be transmitted using a wireless data link that is separate from the cellular voice channels. Data may also be transmitted over the voice channel (e.g., using a modem built into the cellular telephone, by automatically generating touch-tone signals that may be recognized by the interactive voice response system at transaction processing and subscription management system 24, or using any other suitable arrangement). These approaches may be used even if the user receives racing data and other information for the service using a platform other than a telephone-based platform.

Users with user television equipment 22 may interact with the service by sending data (e.g., wager data) to transaction processing and subscription management system 24 using path 44i or using paths 44f and 44j. Users with user computer equipment 20 may send data (e.g., wager data) to transaction processing and subscription management system 24 via path 44h or paths 44d and 44j. Users at any user equipment may send data for the service to locations other than transaction processing and subscription management system 24. For example, the user may provide information directly to customer service facility 36, etc.

If desired, the user may send data to the service at transaction processing and subscription management system 24 using different paths than those used to receive data from transaction processing and subscription management system 24. For example, racing data may be received at user television equipment 22 via paths 44j and 44f, whereas data may be sent by the user from user television equipment 22 to transaction processing and subscription management system 24 using path 44i, etc. Moreover, the paths used to receive certain video information may be different from those used to receive racing data. For example, user television equipment 22 may receive racing videos using path 44f, but may receive racing data using path 44i. These examples are merely illustrative. Any suitable combination of paths may be used to distribute racing data and other information for the interactive wagering service, any suitable combination of paths may be used to receive videos, and any suitable combination of paths may be used to send data to the wagering service.

If desired, the user may interact with the wagering service using more than one platform. For example, the user may place a wager using a cellular telephone while the user is driving home. When the user arrives home, the user may determine the outcome of the wager by watching a video of the race on user television equipment. Later in the day, the user may check the user's account balance using a personal computer. This is merely an illustrative example. The various wagering platforms may be used in any suitable combination.

Although system 10 has been described in the context of a system that supports multiple wagering platforms, system 10 may support fewer platforms if desired. For example, aspects of the invention may be implemented using a system 10 that only supports cellular telephone wagering or wagering using handheld computer devices. If desired, system 10 may be configured so that it does not support personal computer wagering, wagering with standard telephones, or wagering with user television equipment. The system may support cellular telephones and/or handheld computing devices such as personal digital assistants, palm-sized computers, etc. in combination with any other suitable platform.

The interactive wagering application may be implemented using application software that runs primarily on a set-top box or other such local platform or using a remote server or other computer that is accessed from a local platform. Arrangements in which interactive wagering services are implemented using software on remote computers that are accessed on-demand from local platforms may be referred to as client-server arrangements. Such client-server arrangements may be used to allow client processes on set-top boxes or personal computers to access server processes running on servers located at cable system headends or other television distribution facilities 18 (FIG. 1) or on remote servers accessed over a communications network. Regardless of the type of system architecture or platform used, the software that supports the interactive wagering service features described herein may be referred to as an interactive wagering application.

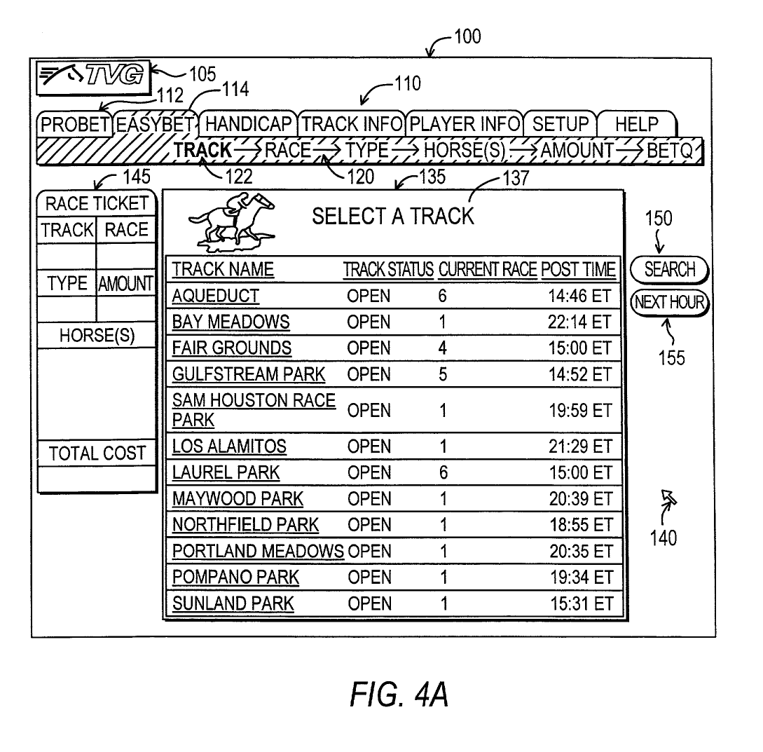

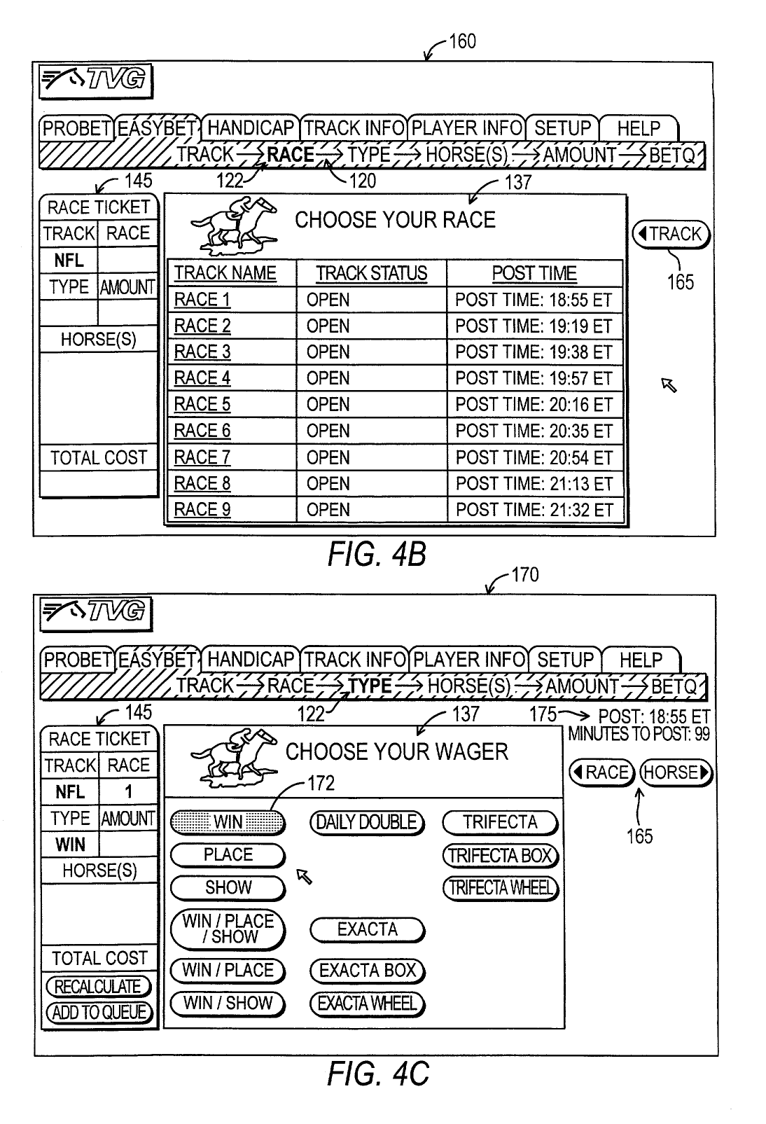

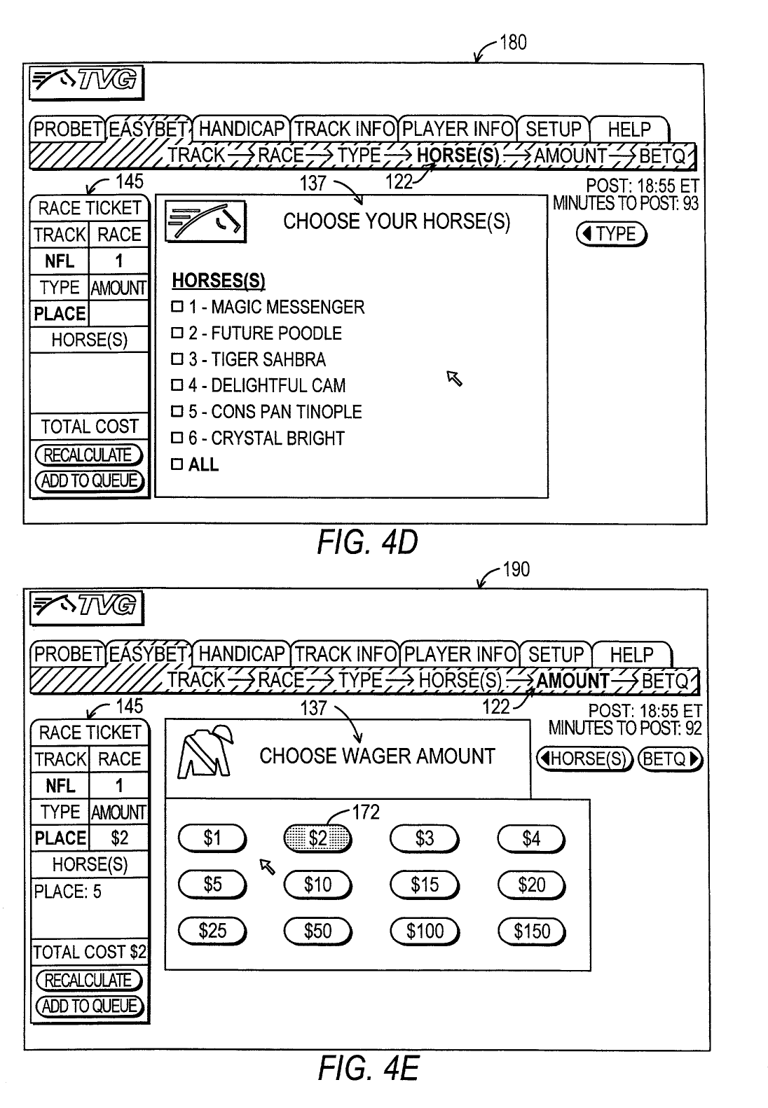

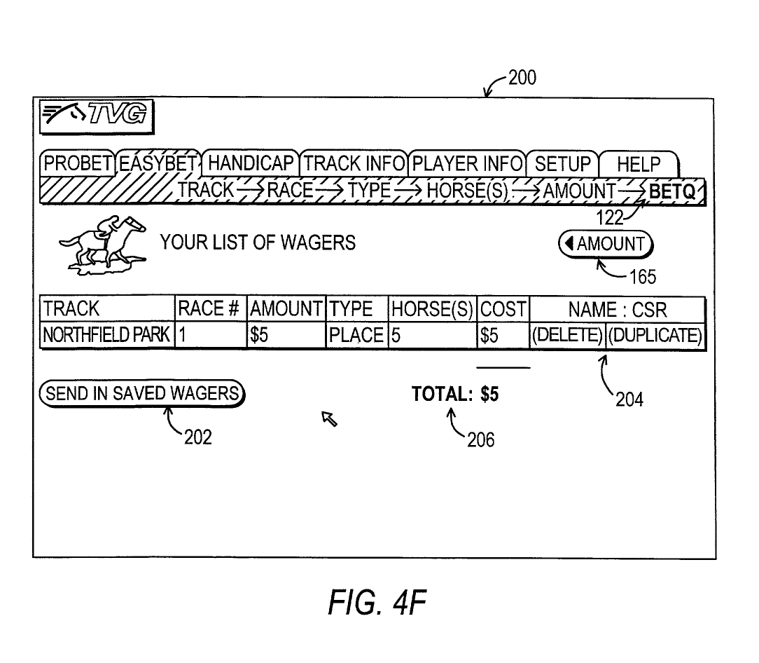

An illustrative display screen that may be provided by the interactive wagering application, and particularly by an interactive wagering application implemented using user computer equipment 20, is shown in FIG. 4A. Screen 100 may be accessed in a variety of ways. For example, a user may initially be provided with an opportunity to launch the interactive wagering application or the interactive wagering application may be web based and the user may access the application through a Web browsing application.

The first screen displayed by the interactive wagering application when it is launched may be an application login screen. In order for the user to enter the application, a proper Account ID, password, and state where the user is located may have to be entered. If the proper information is entered by the user, screen 100 of FIG. 4A may be displayed.

Screen 100 includes tabs 110 that show the user the different options available within the application and indicate the current status of the application. The different options that may be available are “proBet,” “easyBet,” “Handicap,” “Track Info,” “Player Info,” “Setup,” and “Help.” “EasyBet” tab 114 is displayed differently from the other tabs to indicate that the application is currently within “easyBet.” “EasyBet” tab 114 may, for example, be displayed in a different color such as the color of indicator bar 120. Indicator bar 120 in FIG. 4A indicates the current status of the interactive wagering application within “easyBet.”

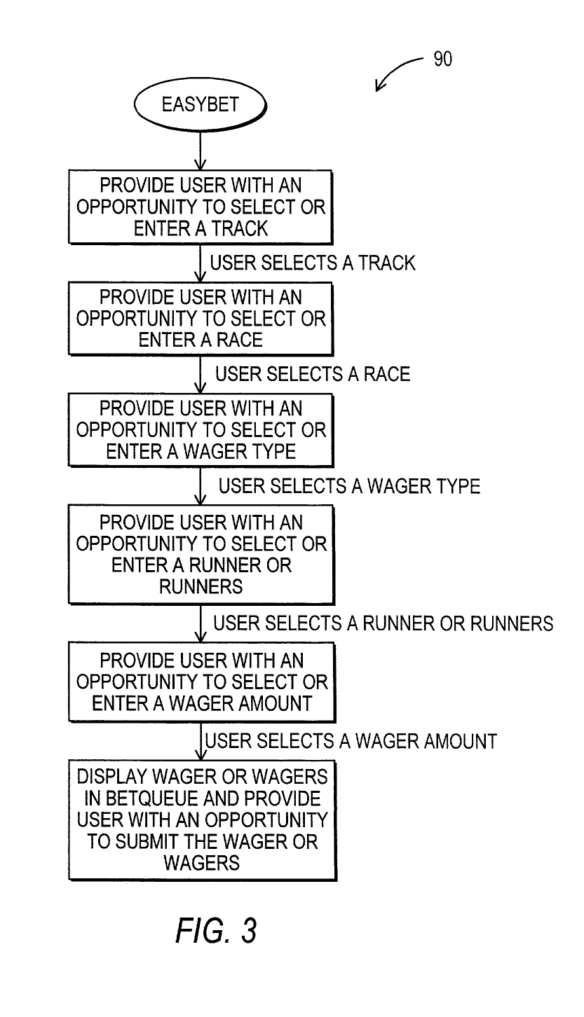

“EasyBet” provides a novice interface for the less experienced wagerer that allows a wager to be created. “EasyBet” presents an interactive sequence of screens designed to guide the user through the steps of creating a wager as illustrated in FIG. 3. This is in contrast to the “proBet” mode, which can be accessed by “proBet” tab 112, that may be designed for an experienced wagerer. “ProBet” provides a very efficient interface where the user can typically make all of the selections required to create a wager on a single screen with a minimum amount of information. Further aspects of “easyBet” and “proBet” are disclosed in Connie T. Marshall et al. U.S. patent application Ser. No. 09/330,651, filed Jun. 11, 1999 (Attorney Docket No. ODS-5, which is hereby incorporated by reference herein in its entirety—the “easybet” name which is used herein is referred to as “Build-A-Bet” in the incorporated reference).

As shown in flow chart 90 of FIG. 3 and as illustrated by indicator bar 120 of FIGS. 4A-4F, the sequence of steps that may be involved in creating a wager may be: selecting a racetrack, selecting a race, selecting a wager type, selecting a runner or runners, and selecting a wager amount. The sequence of steps may, however, be presented in a different order. For example, selecting a wager amount may be presented before selecting a runner or runners. Indicator bar 120 in FIGS. 4A-F may include highlight 122 that indicates the current step in creating a wager.

In screen 100 of FIG. 4A, the user is prompted to select a track for the wager. Screen 100 includes window 135, which may include an action indicator 137 that indicates to the user the next action to be taken. The tracks that are available for the current day may be displayed in window 135 along with additional track information, such as corresponding track status, current race, and post time for the current race. With user computer equipment 20, the track selections are preferably made by clicking on the desired track with pointer 140, which may, for example, be controlled with a mouse or trackball. The selections may also be made by entering the track name or by moving a moveable highlight (not shown) with arrow keys to the desired selection.

Screen 100 also includes interactive race ticket 145, which shows a simulated wagering ticket that is updated as the user makes his or her selections. An operator icon 105 may also be displayed. Search option 150 and next hour option 155 will be described in detail below.

Once the user has selected an available track, screen 160 may displayed as shown in FIG. 4B. As illustrated, interactive race ticket 145 shows “NFL” as the track selected by the user. “NFL” is an abbreviation for the track “Northfield Park.” Action indicator 137 and highlight 122 have been updated to indicate to the user that the next action is to choose a race. Screen 160 may include browsing button 165. Browsing button 165 may allow the user to return to screen 100 and enter a new track selection. The user may also be able to return to the track selection by clicking or selecting “Track” in indicator bar 120.

Once the user has selected a desired race, screen 170 may be displayed as shown in FIG. 4C. As illustrated, interactive race ticket 145 shows that race “1” has been selected. Action indicator 137 and highlight 122 have been updated to indicate to the user that the next action is to select a wager type. The application may select a default wager type selection, such as “Win”, as indicated by interactive race ticket 145 and highlight region 172, or any other suitable wager type. Screen 170 may also include race countdown 175. Race countdown 175 informs the user how much time remains until post time. If there are only a few minutes to post, the user may desire to quickly place a wager to insure that the wager is accepted in time. Browsing buttons 165 allow the user to navigate to the previous screen or advance to the next screen within “easyBet.” If the user decides to advance to the next screen by selecting the browsing button “Horse,” the interactive wagering application will accept the default wager selection “Win” as the user's desired wager type. Alternatively, the user may advance to the next screen by selecting a wager type option within window 135 or by selecting “Horse(s)” in indicator bar 120.

Once the user has selected a desired wager type, screen 180 may be displayed as shown in FIG. 4D. As illustrated, interactive race ticket 145 shows that the wager type “Place” has been selected. Action indicator 137 and highlight 122 have been updated to indicate to the user that the next action is to select one or more horses. For a wager type that requires a single horse selection, if the user selects more than one horse, then the number of bets placed is equal to the number of horses selected. Alternatively, if the user had selected a wager type that requires more than one horse to be selected, such as an exacta wager, then two or more horse selections may be required for a single bet.

Once the user has selected a desired horse or horses, screen 190 may be displayed as shown in FIG. 4E. As illustrated, interactive race ticket 145 shows that horse “5,” which is “Cons Pan Tinople,” has been selected. Action indicator 137 and highlight 122 have been updated to indicate that the next action is to select a wager amount. The interactive wagering application may select a default wager amount such as “$2” as indicated by interactive race ticket 145 and highlight region 172 or any other suitable wager amount. Interactive race ticket 145 may include total cost information separate from the wager amount information. If the wager includes more than one bet, then the wager amount selected is the amount for each bet. Therefore, the total cost of the wager may be more than the wager amount selected.

Once the user has selected a desired wager amount, “BetQ” screen 200 may be displayed as shown in FIG. 4F. As illustrated, screen 200 shows wager information for the wager that the user created. At this point, the user may review the wager. If the user decides to change the wager, the user may use browse button 165 or indicator bar 120 to navigate to any of the previous screens of FIGS. 4A-E to modify the wager. If the wager is satisfactory, the user may select action selection 202 to submit the wager to transaction processing and subscription management system 24 or other suitable systems or facilities for submission to totalisators 30. Screen 200 may also includes additional options for the wager such as “Delete” and “Duplicate” options 204. The interactive wagering application may also, at this point, provide the user with an option to create a new wager. If the user decides to create a new wager, the existing wager may remain in the “BetQ.” Total indicator 206 shows the user the total amount of the wagers that are listed in the “BetQ.”

Screens such as the screens shown in FIGS. 4A-F are merely illustrative. The interactive wagering application may use any suitable screens to allow the user to enter or select the information for creating a wager.

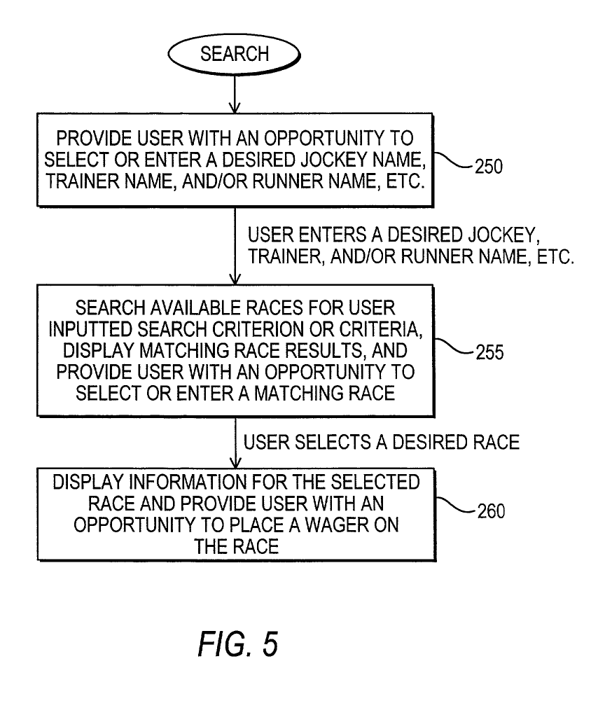

FIG. 5 shows a flow chart of illustrative steps for providing the user with a search feature that allows the user to search for races based on user inputted search criterion. At step 250, the interactive wagering application may provide the user with an opportunity to select or enter a desired jockey name, trainer name, runner name, or other suitable search criteria or any suitable combination thereof. The search categories available to the user may depend on the type of races that are available to the user.

At step 255, the interactive wagering application may search through races that are available to be wagered upon for the user inputted search criterion or criteria and display the search results. The search results may be displayed ordered according to track and then race. If two or more search criterion were entered, the interactive wagering application may display search results that match each criterion and that match all of the criteria. At this time the interactive wagering application may also provide the user with an opportunity to obtain additional information and place a wager on a desired race from the search results.

At step 260, the interactive wagering application may display information on the desired race and provide the user with an opportunity to place a wager on the race. For example, the application may display handicapping information for the race. The handicapping information may include the post time, the runners and their corresponding morning line odds, real-time odds, jockeys, trainers, or any other suitable information. If the user desires to place a wager on the race, the application may, for example, display a screen requesting the user input of a wager type such as screen 170 of FIG. 4C. This may allow the user to bypass the first few steps of creating a wager, such as screens 100 and 160 of FIGS. 4A and 4B, respectively.

It will be understood that the steps shown in FIG. 5 are merely exemplary and that additional steps may be added and some of the steps may be omitted or modified. For example, step 260 may be omitted and the interactive wagering application may, at step 255, display race information with the race results and provide the user with an opportunity to place a wager on a desired race.

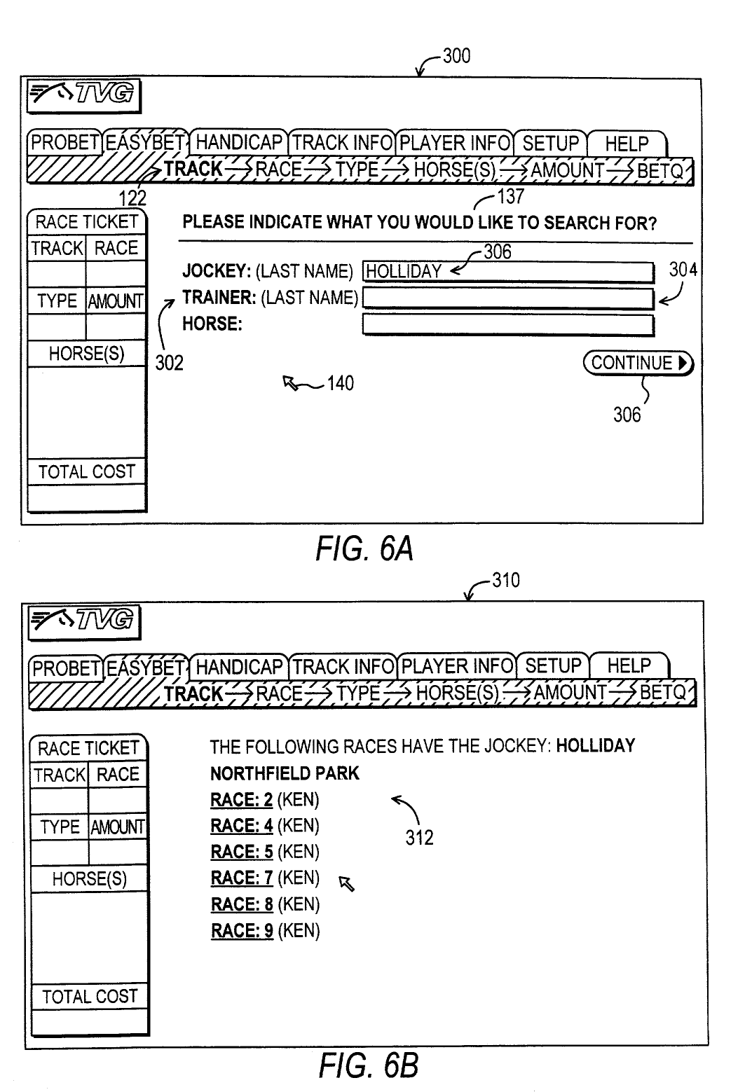

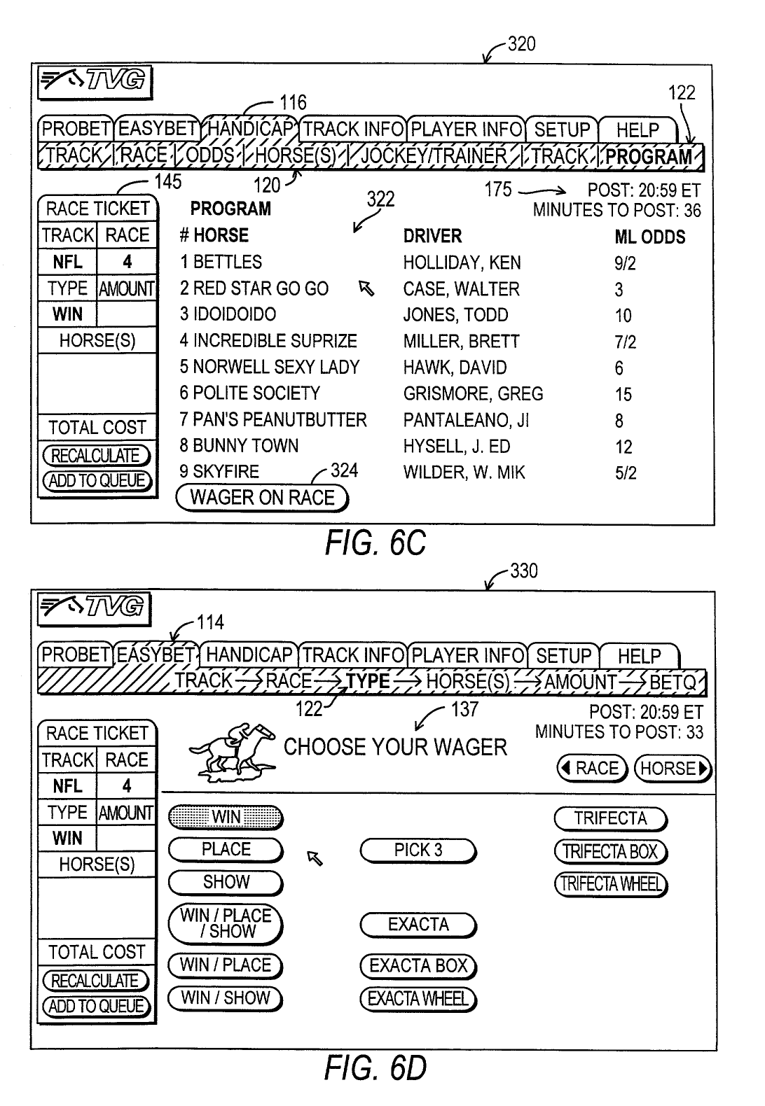

Screen 300 of FIG. 6A shows an illustrative display screen of the search feature described in the flow chart of FIG. 5. Screen 300 may be accessed by selecting search option 150 in screen 100 of FIG. 4A or by any other suitable method. As shown in screen 300, “easybet” tab 114 indicates that the interactive wagering application is currently within “easyBet.” Highlight 122 indicates to the user that a track has not been selected yet for creating a wager. Action indicator 137 indicates to the user that the next action is to enter search criteria. Search option categories 302 indicate to the user the different search options that are available. As illustrated, search option indicators 302 indicate that the user may search for a desired jockey, trainer, horse or any suitable combination thereof. Input fields 304 allow the user to enter search criteria. As illustrated, the user has entered “Holliday” in the jockey category. Depending upon the user equipment, the user may enter the search criteria by typing the letters in using a keyboard, touch pad, or a number key pad where the numbers represent letters, by scrolling through letters with arrow keys or by other suitable methods. For example, with user telephone equipment 32, the user may enter the search criteria by scrolling through the alphabet with up and down arrow keys and may select letters with a select key or a right arrow key. Screen 300 may include pointer 140. Pointer 140 may allow the user to click on a specific input field 304 in order to enter a desired search criterion. Screen 300 may also include continue option 306. Continue option 306 allows the user to submit the entered search criterion.

Once the user has submitted the search criterion, screen 310 may be displayed as shown in FIG. 6B. Screen 310 includes search results 312. As illustrated, races “2,” “4,” “5,” “7,” “8,” and “9” at “Northfield Park” have the jockey “Holliday.” Search results 312 may also include the jockey's name, which is Ken, or any other suitable information.

Once the user has selected a race from screen 310, screen 320 may be displayed as shown in FIG. 6C. “Handicap” tab 116 indicates that the interactive wagering application is currently within “Handicap.” “Handicap” provides the user with handicapping information and other race information. As illustrated by indicator bar 120, some of the information available to the user in “Handicap” may include “Track,” “Race,” “Odds,” “Horse,” “Jockey/Trainer,” “Track,” and “Program” information. Highlight 122 indicates to the user that the interactive wagering application is currently displaying program information. Screen 320 may include interactive race ticket 145, race countdown 175, and program information 322. Interactive race ticket 145 shows that race “4” of “Northfield Park” has been selected. Race countdown 175 indicates that there are “36” minutes to post time. “Program” information 322 may include horse names, their jockeys, the morning line odds, and any other suitable information. Wager option 324 allows the user to create a wager on the race.

If the user selects wager option 324 of screen 320, the interactive wagering application may display screen 330 as shown in FIG. 6D. “EasyBet” tab 114 indicates that the interactive wagering application is currently within “easyBet.” Action indicator 137 and highlight 122 indicate to the user that the next action is to select a wager type. The interactive wagering application at screen 330 is at the same step of the wager creation process as screen 170 of FIG. 4C. Therefore, if the user desires to create and place a wager, the user may select a wager type from screen 330 and the interactive wagering application may present the user with screens similar to the screens shown in FIGS. 4D-F.

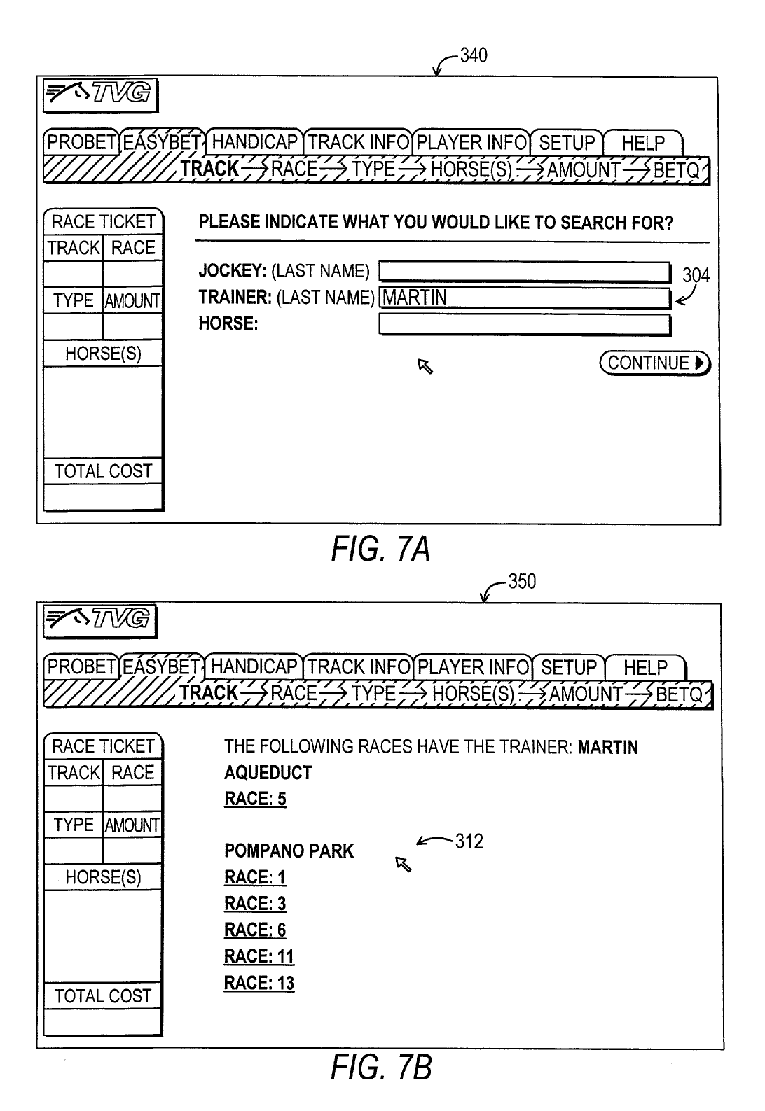

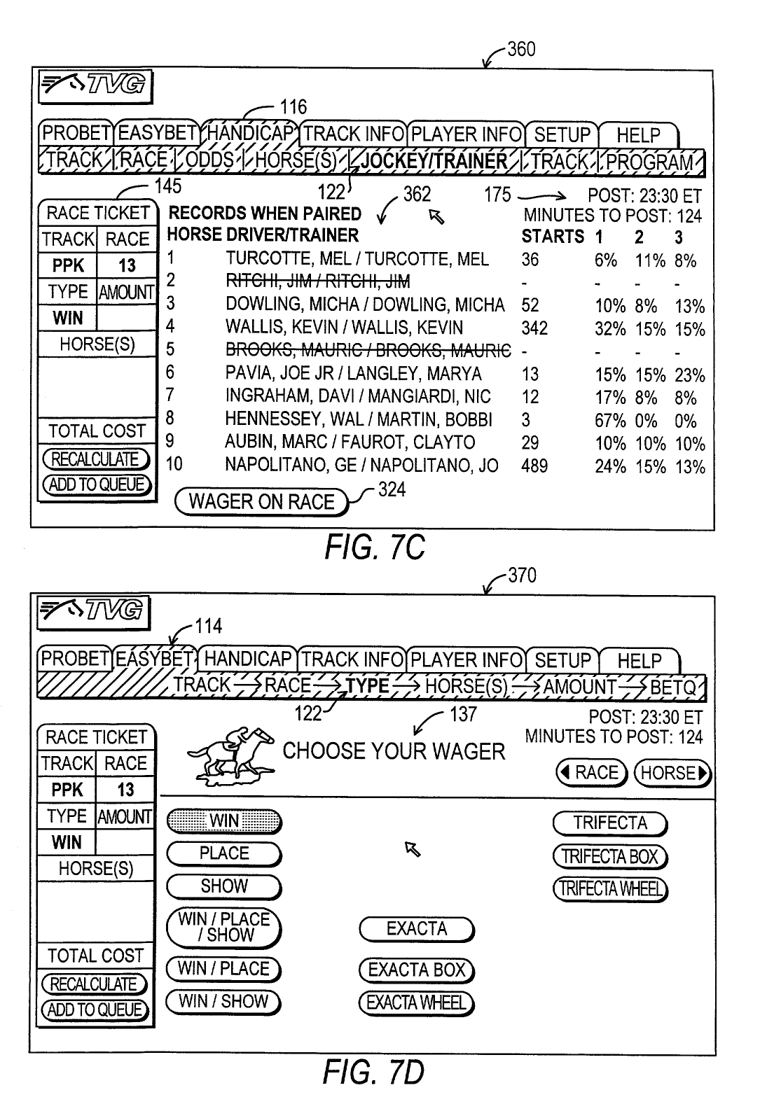

Screen 340 of FIG. 7A shows another illustrative display screen of the search feature described in the flow chart of FIG. 5. The function of screen 340 is the same as screen 300 of FIG. 6A. The user, however, in screen 340 desires to search for a desired trainer. As illustrated in screen 340, the user has entered “Martin” in the trainer category.

Once the user has submitted the search criterion, screen 350 may be displayed as shown in FIG. 7B. Screen 350 includes search results 312. As illustrated, races at two racetracks satisfy the search criterion. Race “5” at “Aqueduct” and races “1,” “3,” “6,” “11,” and “13” at “Pompano Park” include runners that have “Martin” as their trainer. Search results 312 may also include the trainer's first name or any other suitable information.

Once the user has selected a race from screen 350, screen 360 may be displayed as shown in FIG. 7C. “Handicap” tab 116 and highlight 122 indicate that the interactive wagering application is currently displaying “Jockey/Trainer” information within “Handicap.” Screen 360 may include interactive race ticket 145, race countdown 175, and “Jockey/Trainer” information 362. Interactive race ticket 145 shows that race “13” of “Pompano Park” has been selected. Race countdown 175 indicates that there are “124” minutes to post time. “Jockey/Trainer” information 362 may include the horse numbers, jockey and trainer names, the number of starts together, and the percentages of finishes in 1st, 2nd, and 3rd place, and any other suitable information. Wager option 324 allows the user to create a wager on the race.

If the user selects wager option 324 in screen 360, the interactive wagering application may display screen 370 as shown in FIG. 7D. “EasyBet” tab 114 indicates that the interactive wagering application is currently within “easyBet.” Action indicator 137 and highlight 122 indicate to the user that the next action is to select a wager type. The interactive wagering application at screen 370 is at the same step of the wager creation process as screen 330 of FIG. 6D and screen 170 of FIG. 4C. Therefore, if the user desires to create and place a wager, the user may select a wager type from screen 370 and the interactive wagering application may present the user with screens similar to the screens shown in FIGS. 4D-F.

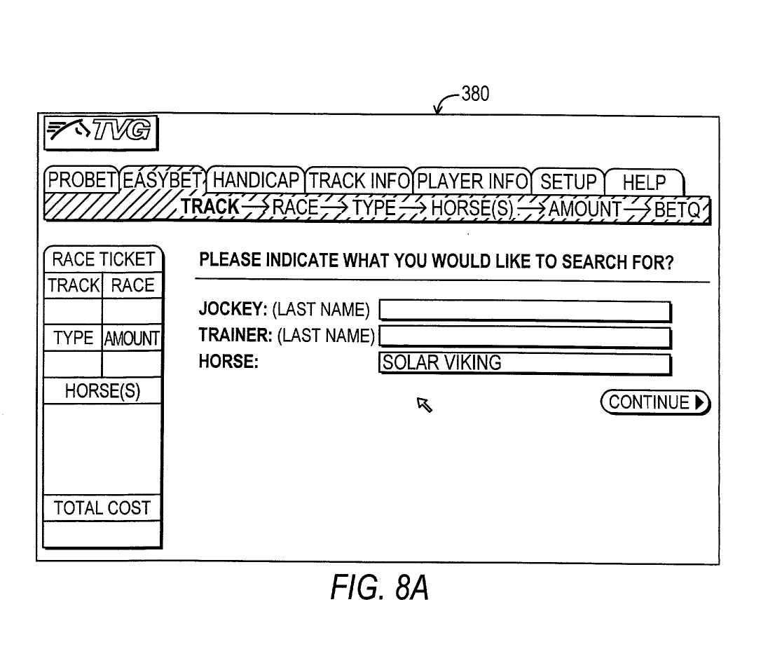

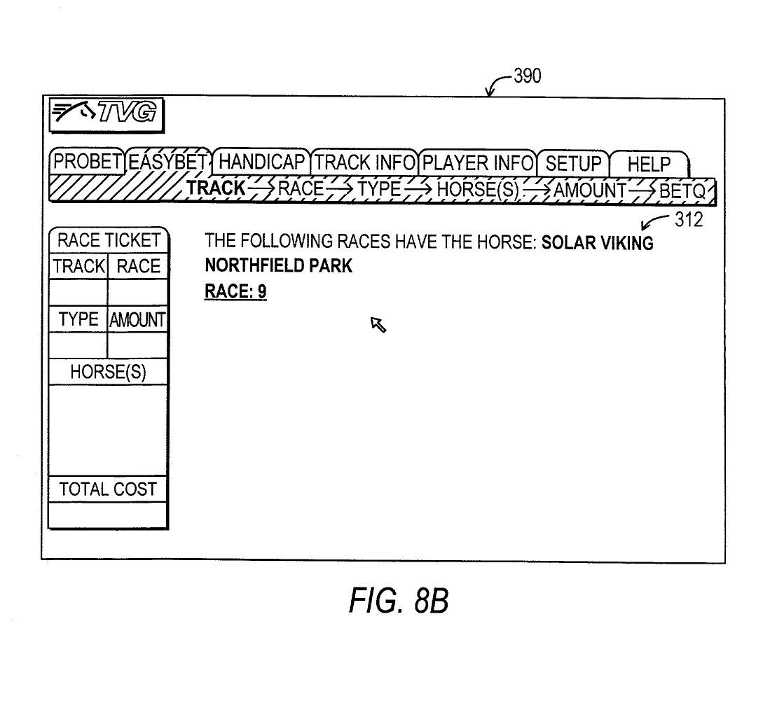

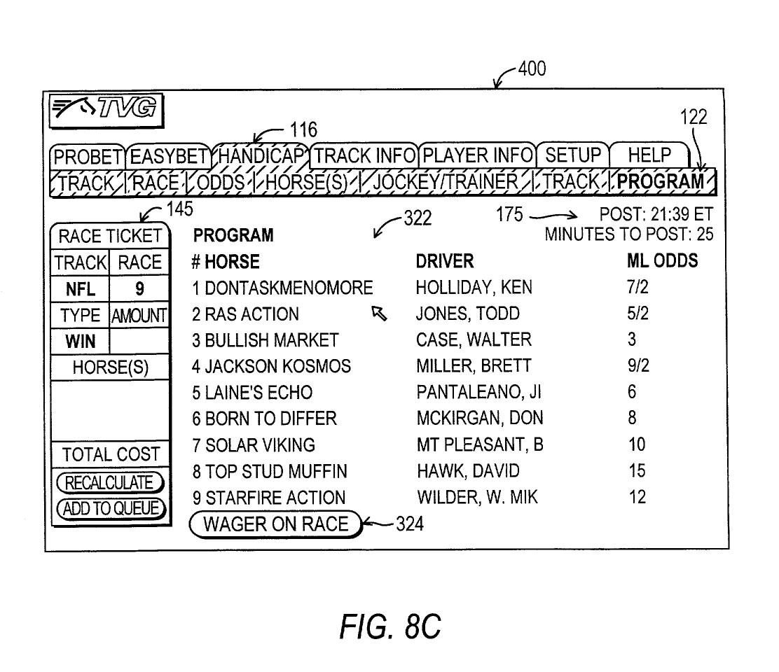

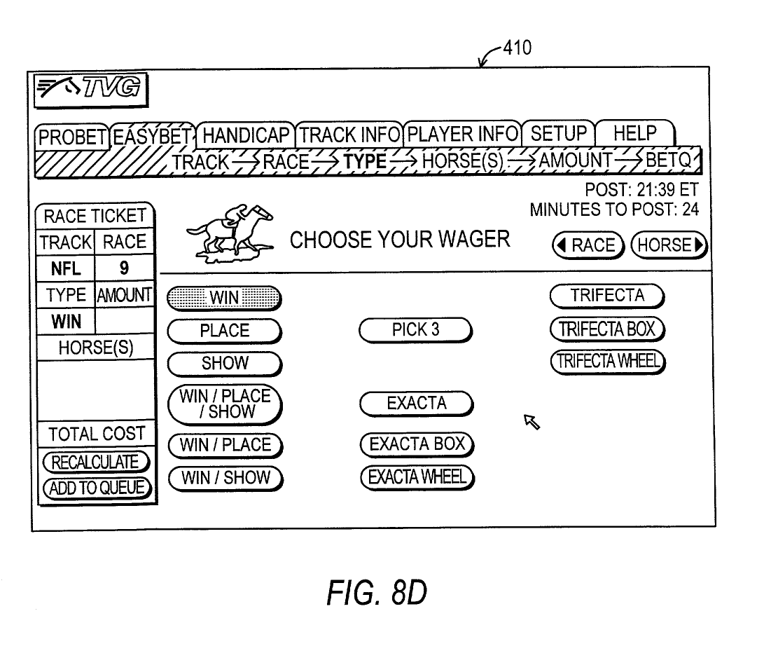

The screens shown in FIGS. 8A-D illustrate additional screens of the search feature described in the flow chart of FIG. 5. In screen 380 of FIG. 8A, the user has entered “Solar Viking” as the search criterion in the horse category.

Once the user has submitted the search criterion, screen 390 may be displayed as shown in FIG. 8B. Screen 390 includes search results 312. As illustrated, race “9” at “Northfield Park” is the only race that satisfies the search criterion. Search results 312 may also include additional information, such as the jockey and trainer names for the horse or any other suitable information.

If the user selects race “9” from screen 390, screen 400 may be displayed as shown in FIG. 8C. “Handicap” tab 116 and highlight 122 indicate that the interactive wagering application is currently displaying “Program” information within “Handicap.” Screen 400 may include interactive race ticket 145, race countdown 175, and program information 322. Interactive race ticket 145 shows that race “9” of “Northfield Park” has been selected. Race countdown 175 indicates that there are “25” minutes to post time. Wager option 324 allows the user to create a wager on the race.

If the user selects wager option 324 in screen 400, the interactive wagering application may display screen 410 as shown in FIG. 8D. Screen 410 allows the user to select a wager type. If the user selects a desired wager type, the user may be presented with screens similar to the screens shown in FIGS. 4D-F.

It will be understood that the screens shown in FIGS. 6A-8D are merely illustrative of the search feature described in the flow chart of FIG. 5 and any other suitable arrangement may be used.

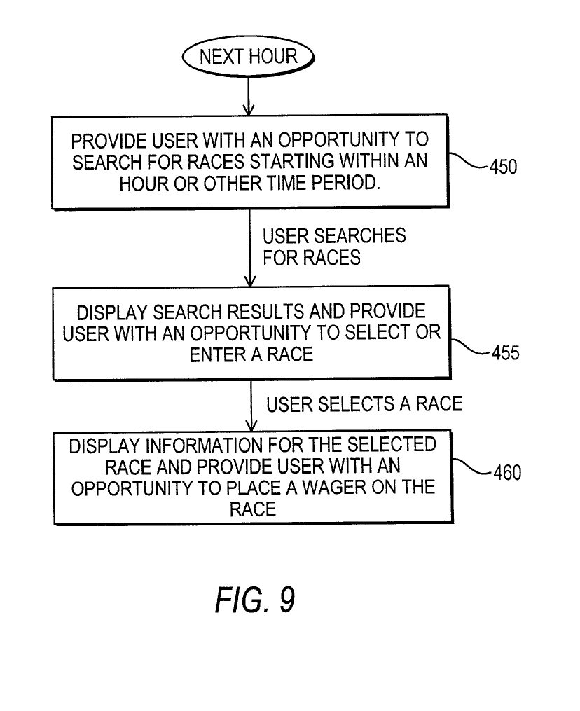

FIG. 9 shows a flow chart of illustrative steps for providing the user with a next hour feature that allows the user to search for upcoming races that will be run within a certain period of time. For example, the next hour feature may allow users to search for races that will be run within the next 5, 10, 20, 30, 45, 60 minutes or within any other suitable time period. Alternatively, the next hour feature may provide the user with the next 10 or any other suitable number of races that will be run. This feature is referred to as next hour for purposes of illustration and not of limitation. At step 450, the interactive wagering application may provide the user with an opportunity to search for races that are starting within an hour or other suitable time period.

At step 455, the interactive wagering application may display the search results and provide the user with an opportunity to select a desired one of the displayed races. The search results may include the race number, racetrack name, post time, or any other suitable information. The search results may be displayed ordered according to post time, racetrack, or by any other suitable method.

At step 460, the interactive wagering application may display information on the desired race and provide the user with an opportunity to place a wager on the race. For example, the application may display handicapping information and other race information for the desired race. The information may include the post time, the runners and their corresponding morning line odds, real-time odds, jockeys, trainers, or any other suitable information. If a user desires to place a wager on the race, the interactive wagering application may, for example, display a screen requesting the user input of a wager type such as screen 170 of FIG. 4C. This feature may therefore allow the user to bypass the first few steps of creating a wager such as screens 100 and 160 of FIGS. 4A and 4B, respectively.

It will be understood that the steps shown in FIG. 9 are merely exemplary and that additional steps may be added and some of the steps may be omitted or modified. For example, step 460 may be omitted and the interactive wagering application may, at step 455, display race information with the search results and provide the user with an opportunity to place a wager on a desired race.

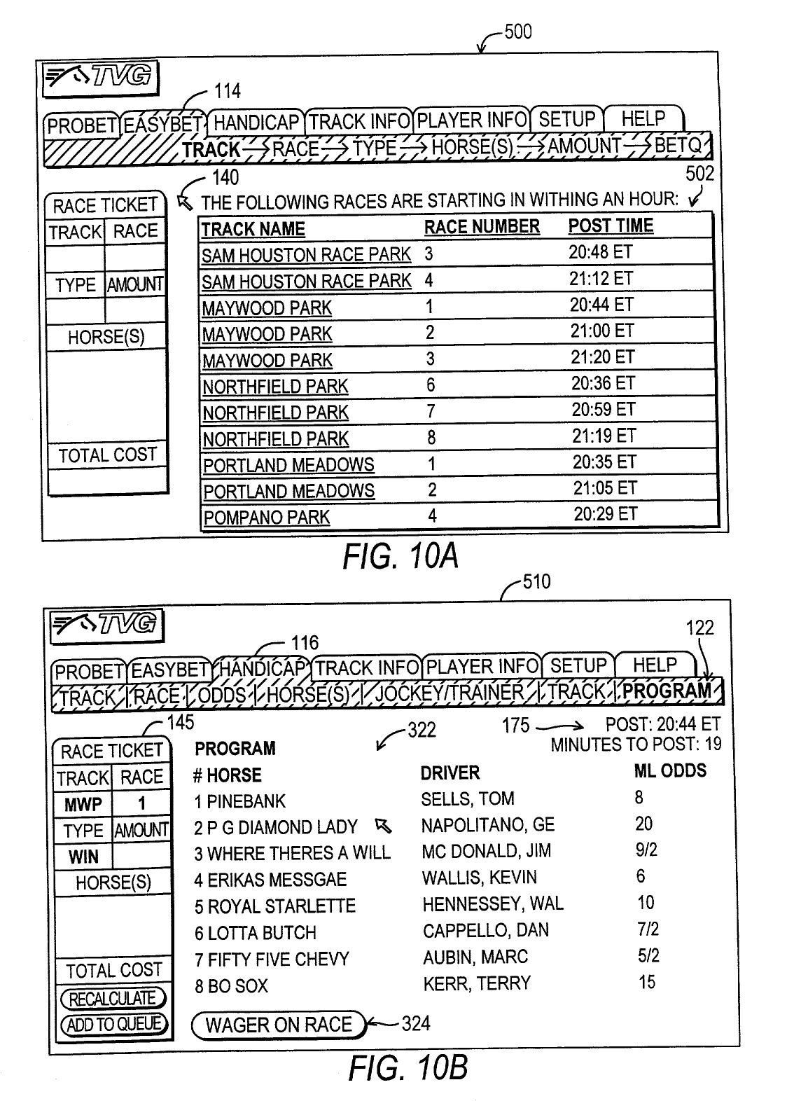

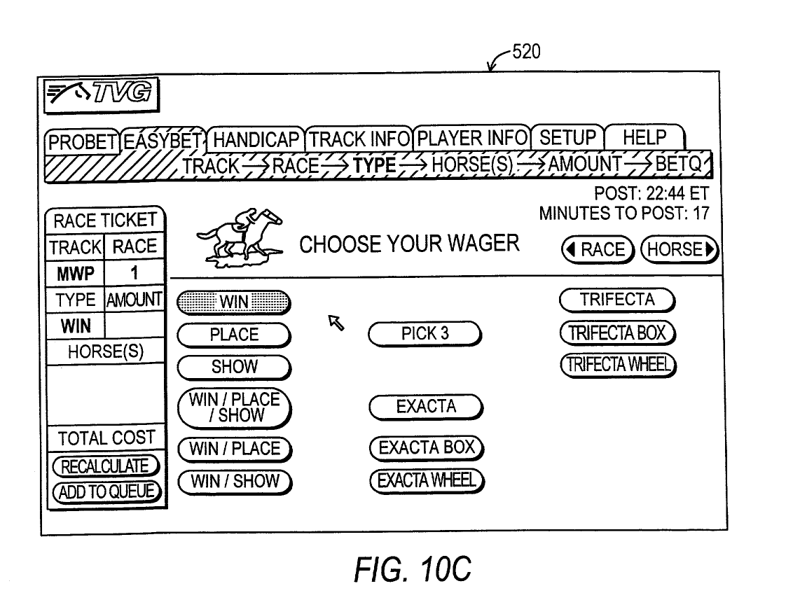

Screen 500 of FIG. 10A shows an illustrative display screen of the next hour feature described in the flow chart of FIG. 9. Screen 500 may be accessed by selecting next hour option 155 in screen 100 of FIG. 4A or by any other suitable method. As shown in screen 500, “easyBet” tab 114 indicates that the interactive wagering application is currently within “easyBet”. Screen 500 includes search results 502. As shown in screen 500, search results 502 include all of the available races that are to be run within the next hour. Search results 502 may, however, include all of the available races that are to be run within any suitable time period or may list any suitable number of upcoming races that are to be run. Search results 502 may include the “Track Name,” “Race Number,” “Post Time,” or any other suitable information. As illustrated, search results 502 are displayed ordered by “Track Name” and then by “Race Number.” The interactive wagering application may also allow the user to reorder the races. For example, if the user selects a column label such as “Post Time” with pointer 140, the interactive wagering application may reorder the races according to “Post Time.”

Once the user has selected a desired race from search results 502 in screen 500, the interactive wagering application may present the user with screen 510 as shown in FIG. 10B. Handicap tab 116 indicates that the interactive wagering application is currently within “Handicap.” Highlight 122 indicates to the user that the interactive wagering application is currently displaying program information. Screen 320 may include interactive race ticket 145, race countdown 175, and program information 322. Interactive race ticket 145 shows that race “1” of “Maywood Park” has been selected. Race countdown 175 indicates that there are 19 minutes to post time. Program information 322 may include horse names and their associated jockeys, the morning line odds, or any other suitable information. Wager option 324 allows the user to place a wager on the race.

If the user selects wager option 324 in screen 510, the interactive wagering application may display screen 520 as shown in FIG. 10C. Screen 520 may allow a user to select a wager type. If the user selects a desired wager type, the user may be presented with screens similar to the screens shown in FIGS. 4D-F for creating a wager.

It will be understood that the screens shown in FIGS. 10A-C are merely illustrative of the next hour feature described in the flow chart of FIG. 9 and any suitable arrangement may be used.

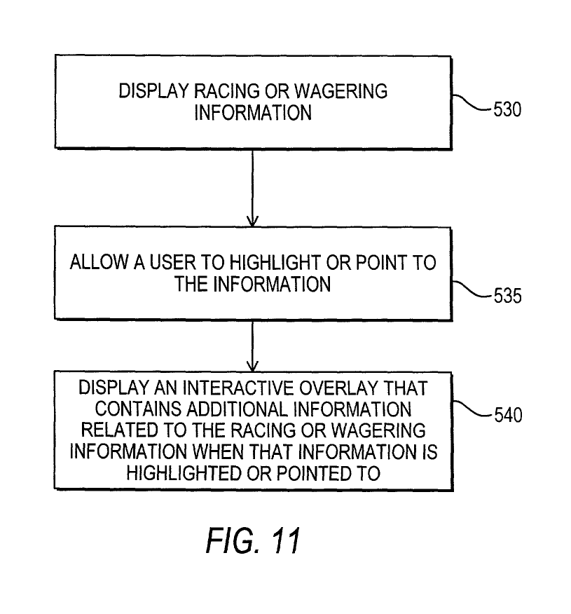

FIG. 11 shows a flow chart of illustrative steps for providing the user with additional information in the form of an interactive overlay. At step 530, the interactive wagering application may display racing information, handicapping information, wagering information, or any other suitable information.

At step 535, the interactive wagering application may provide the user with an opportunity to indicate portions of the displayed information. The user may indicate the portions of information by highlighting or pointing to the portions of information or by any other suitable method.

At step 540, the interactive wagering application may display an interactive overlay that contains additional information related to the portion of information indicated by the user.

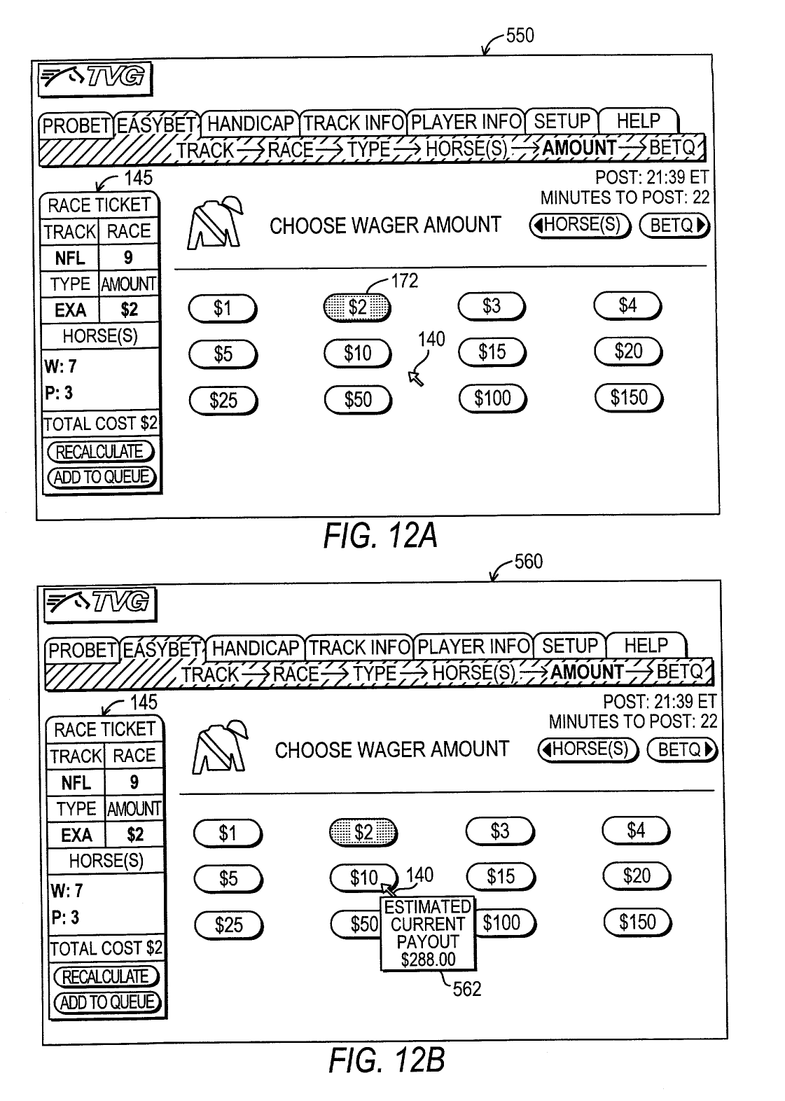

One suitable embodiment of the interactive overlay is illustrated in the display screens of FIGS. 12A-B. Screen 550 of FIG. 12A shows an illustrative “easyBet” display screen where the next action to be taken is selecting a wager amount. Interactive race ticket 145 shows that race “9” at “Northfield Park” has been selected and that the user has selected an “Exacta” wager with horse “7” to come in first and horse “3” to come in second. Highlight region 172 may indicate that a default wager amount has been selected. The user may use pointer 140 to select a desired wager amount.

Screen 560 of FIG. 12B shows screen 550 with pointer 140 positioned on top of the “$10” option. When the user moves pointer 140 on top of the “$10” option or any other wager amount option, the interactive wagering application may display interactive overlay 562. As illustrated, interactive overlay 562 provides the user with the estimated payout of the wager if the user selects the “$10” option. The estimated payout of the wager may be based on the current odds. Interactive overlay 562 may also provide any other suitable information.

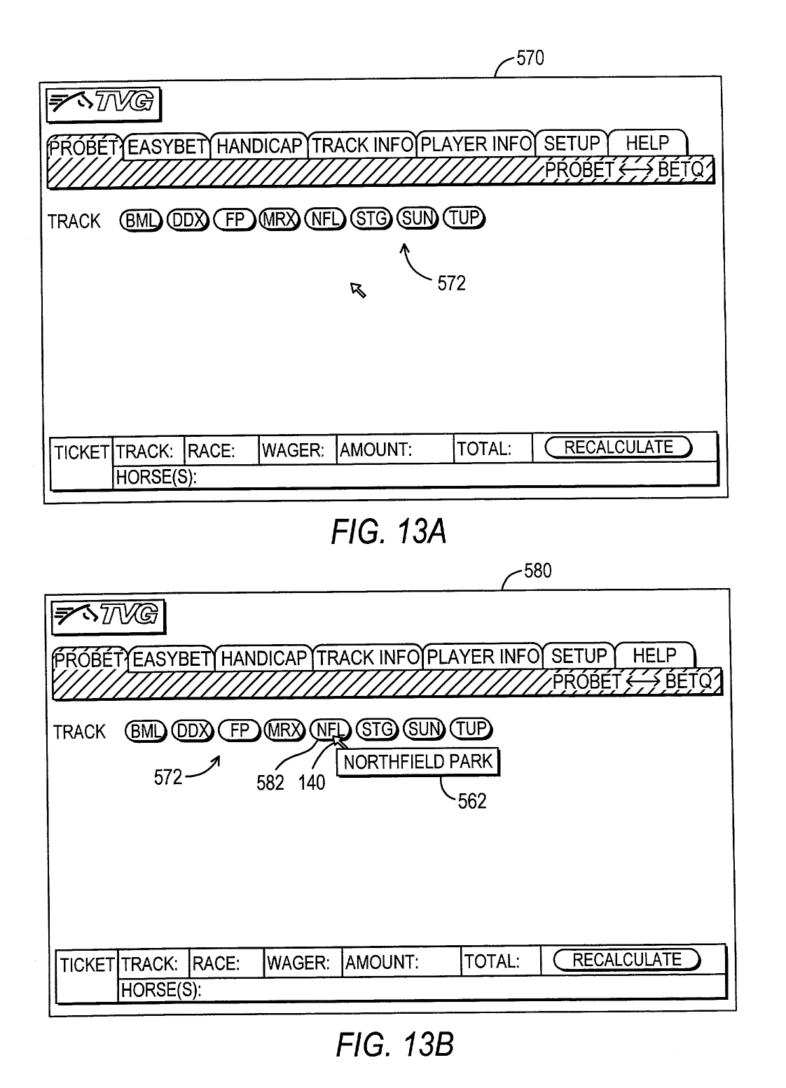

Another suitable embodiment of the interactive overlay is illustrated in the display screens of FIGS. 13A-B. Screen 570 of FIG. 13A shows an illustrative “proBet” display screen where the next action to be taken is selecting a racetrack. Racetrack icons 572 may include abbreviations of the track names. An experienced user may know to what tracks the abbreviations refer. However, if the user is not familiar with a particular abbreviation, the user may desire additional information.

Screen 580 of FIG. 13B shows screen 570 with pointer 140 positioned on top of “NFL” racetrack icon 582. With pointer 140 positioned on top of one of racetrack icons 572, the interactive wagering application may display interactive overlay 562. As illustrated, interactive overlay 562 displays “Northfield Park” to provide the user with the full name of the racetrack. Interactive overlay 562 may also display any other suitable information related to the racetrack such as the current weather conditions or the next race to be run at the racetrack.

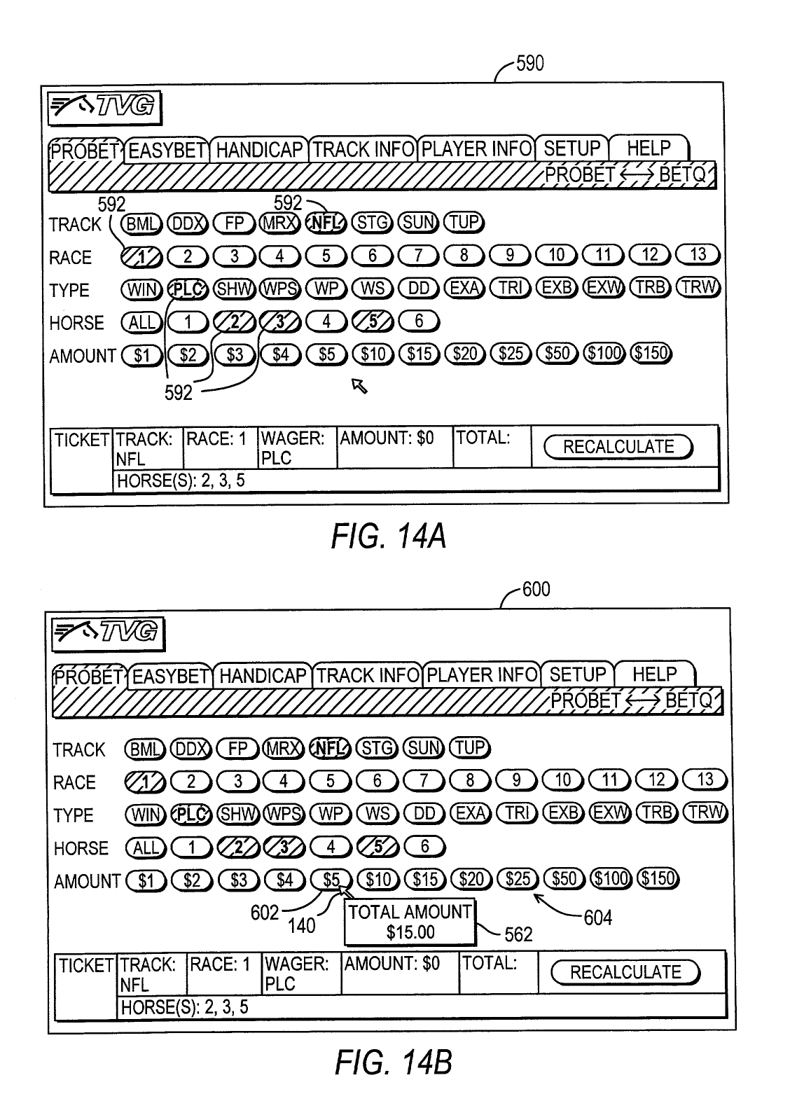

Another suitable embodiment of the interactive overlay is illustrated in the display screens of FIGS. 14A-B. Screen 590 of FIG. 14A shows an illustrative “proBet” display screen where the next action to be taken is selecting a wager amount. Icons 592 indicate wagering options previously selected by the user. As illustrated, the user has selected horses “2,” “3,” and “5” for a place wager on race “1” at “Northfield Park.”

Screen 600 of FIG. 14B shows screen 590 with pointer 140 positioned on top of “$5” icon 602. With pointer 140 positioned on top of one of wager amount icons 604, the interactive wagering application may display interactive overlay 562. As illustrated, interactive overlay 562 displays that the total amount of the wager is “$15.” Because the user has selected three horses for the “Place” wager, the wager is for three separate “Place” bets. Interactive overlay 562 may also display any other suitable information related to the wager. For example, interactive display 562 may display the estimated payout for each “Place” bet.

It will be understood that the screens shown in FIGS. 12A-14B are merely illustrative of the interactive overlay feature described in the flow chart of FIG. 11 and that any other suitable arrangement may be used. For example, the interactive wagering application may display the interactive overlay when the user indicates a wager type icon that contains an abbreviation of the wager type. The displayed interactive overlay may contain the full form of the wager type abbreviation, the size of its associated wager pool, or any other suitable information. The interactive wagering application may also display the interactive overlay when a user indicates a horse number. The displayed interactive overlay may contain the horse name, its associated jockey or trainer name, real-time odds, morning line odds, the horse's power rating, or any other suitable information.

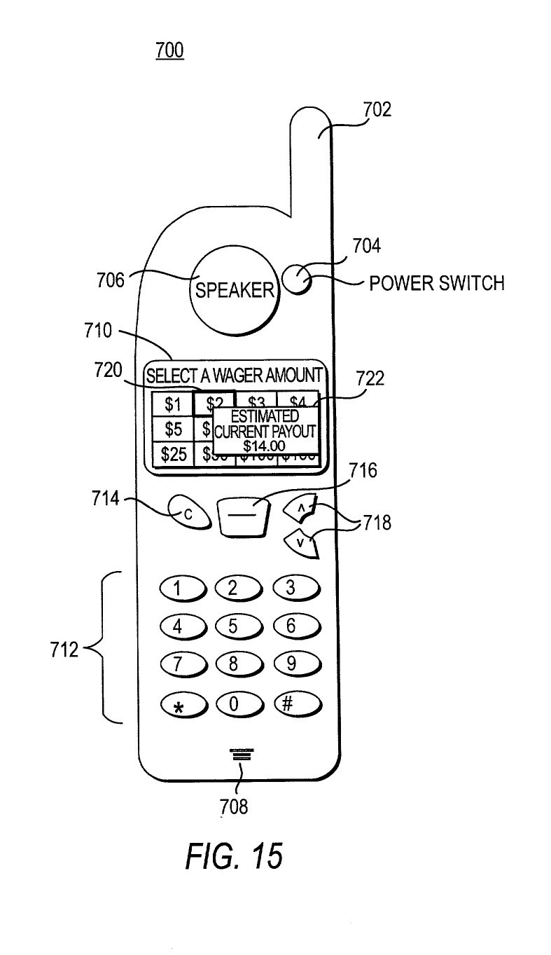

While the foregoing illustrative display screens have been presented for use primarily with user computer equipment 20 and user television equipment 22, it will be understood that the user will be able to access similar display screens with user telephone equipment 32. As discussed above, user telephone equipment 32 may be a cellular telephone. An illustrative cellular telephone 700 with which the user may use the interactive wagering application is shown in FIG. 15.

Cellular telephone 700 may have an antenna 702 to support wireless communications with transaction processing and subscription management system 24, customer service facility 36, or video production system 14 of FIG. 1. A power switch 704 may be used to turn on and off cellular telephone 700. A speaker 706 may allow the user to hear conversations and to hear audio prompts from, for example, transaction processing and subscription management system 24. A microphone 708 allows the user to converse with others. Display screen 710 may be a liquid crystal display (black and white or color), a plasma display, a light-emitting diode display, an active matrix display, or any other suitable type of display screen. Keys 712 allow the user to enter inputs. Numeric keys 712 (including the star and pound key) allow the user to respond to interactive voice response system prompts such as “press 3 to select race 3” and allow the user to enter numbers to select numerically identified on-screen menu options and the like that are displayed on display 710. If desired, some of numeric keys 712 may perform secondary functions if, for example, they are pressed and held for at least a predetermined length of time. Clear key 714 may be used to clear characters from display 710. If the user presses and holds clear key 714, the user may be taken back to the initial screen displayed on display 710 upon power up. Navigation key 716 may be used to access menus, make telephone calls, etc. Scroll keys 718 may be used to scroll through menus and to scroll through other items presented on display screen 710.

Display screen 710 illustrates one suitable embodiment of the interactive overlay in use with user telephone equipment 32. Screen 710 shows an illustrative “easyBet” display screen where the next action to be taken is selecting a wager amount. The user may navigate highlight 720 through the wager amount options with scroll keys 718. As shown in screen 710, the has navigated highlight 720 to the “$2” wager amount. Interactive overlay 722 may be displayed in response to the user indicating a wager amount in order to provide the user with additional information. Interactive overlay 722 may provide the user with the estimated current payout of the wager if the user selects the “$2” option or any other suitable information.

It will be understood that screens similar to the screens of the search feature and the next hour feature may also be implemented on user telephone equipment 32.

Thus, an interactive wagering system is provided that assists users in finding races on which the users desire to wager on and that assists users in placing a wager on the desired race. One skilled in the art will appreciate that the present invention can be practiced by other than the described embodiments, which are presented for purposes of illustration and not of limitation, and the present invention is limited only by the claims which follow.

The invention claimed is

1. A method for searching for available races in an interactive wagering system, comprising:
allowing a user to input a race criterion;
searching through available races for the user inputted race criterion; and
displaying race results of the search.

2. The method defined in claim 1 wherein the race criterion is jockey name.

3. The method defined in claim 1 wherein the race criterion is horse name.

4. The method defined in claim 1 wherein the race criterion is trainer name.

5. The method defined in claim 1 further comprising:
allowing the user to input a plurality of race criterion;
searching through the available races for the user inputted plurality of race criterion; and
displaying race results of the search for the plurality of race criterion.

6. The method defined in claim 1 wherein the race results include race number and racetrack name.

7. The method defined in claim 1 further comprising:
allowing the user to select a race from the race results; and
displaying information associated with the selected race in response to the user selecting the race.

8. The method defined in claim 7 further comprising providing the user with an opportunity to place a wager on the selected race.

9. An interactive wagering system comprising user equipment that allows a user to search for available races, wherein the interactive wagering system is configured to:
allow the user to input a race criterion;
search through available races for the user inputted race criterion; and
display race results of the search.

10. The interactive wagering system defined in claim 9 further comprising user television equipment, wherein the user television equipment is the user equipment.

11. The interactive wagering system defined in claim 9 further comprising user computer equipment, wherein the user computer equipment is the user equipment.

12. The interactive wagering system defined in claim 9 further comprising user telephone equipment, wherein the user telephone equipment is the user equipment.

13. The interactive wagering system defined in claim 9 wherein the race criterion is jockey name.

14. The interactive wagering system defined in claim 9 wherein the race criterion is horse name.

15. The interactive wagering system defined in claim 9 wherein the race criterion is trainer name.

16. The interactive wagering system defined in claim 9 wherein the interactive wagering system is further configured to:
allow the user to input a plurality of race criterion;
search through the available races for the user inputted plurality of race criterion; and
display race results of the search for the plurality of race criterion.

17. The interactive wagering system defined in claim 9 wherein the race results include race number and racetrack name.

18. The interactive wagering system defined in claim 9 wherein the user equipment is configured to:
allow the user to select a race from the race results; and
display information associated with the selected race in response to the user selecting the race.

19. The interactive wagering system defined in claim 9 wherein the user equipment is configured to provide the user with an opportunity to place a wager on the selected race.

20. A method for searching for races to be run in an interactive wagering system, comprising:
allowing a user to search for upcoming races that are to be run within a given period of time; and
displaying race results of the races that are to be run within the given period of time.

21. The method defined in claim 20 wherein the given period of time is one hour.

22. The method defined in claim 20 wherein the race results include race number, racetrack name, and post time of the races that are to be run within the given period of time.

23. The method defined in claim 20 further comprising allowing the user to sort the race results.

24. The method defined in claim 20 further comprising allowing the user to sort the race results according to post time.

25. The method defined in claim 20 further comprising:
allowing the user to select a race from the race results; and
displaying information associated with the selected race in response to the user selecting the race.

26. The method defined in claim 25 further comprising providing the user with an opportunity to place a wager on the selected race.

27. An interactive wagering system comprising user equipment that allows a user to search for available races, wherein the interactive wagering system is configured to:
allow the user to search for upcoming races that are to be run within a given period of time; and
display race results of the races that are to be run within the given period of time.

28. The interactive wagering system defined in claim 27 further comprising user television equipment, wherein the user television equipment is the user equipment.

29. The interactive wagering system defined in claim 27 further comprising user computer equipment, wherein the user computer equipment is the user equipment.

30. The interactive wagering system defined in claim 27 further comprising user telephone equipment, wherein the user telephone equipment is the user equipment.

31. The interactive wagering system defined in claim 27 wherein the given period of time is one hour.

32. The interactive wagering system defined in claim 27 wherein the race results include race number, racetrack name, and post time of the races that are to be run within the given period of time.

33. The interactive wagering system defined in claim 27 wherein the user equipment is configured to allow the user to sort the race results.

34. The interactive wagering system defined in claim 27 wherein the user equipment is configured to allow the user to sort the race results according to post time.

35. The interactive wagering system defined in claim 27 wherein the user equipment is configured to:
allow the user to select a race from the race results; and
display information associated with the selected race in response to the user selecting the race.

36. The interactive wagering system defined in claim 35 wherein the user equipment is further configured to provide the user with an opportunity to place a wager on the selected race.

37. A method for providing information to a user in an interactive wagering system, comprising:
displaying information to the user;
allowing the user to indicate a portion of the information; and
displaying an interactive overlay, in response to the user indicating the portion of information, that contains additional information associated with the portion of information.

38. The method defined in claim 37 further comprising removing the interactive overlay after the portion of information is no longer indicated by the user.

39. The method defined in claim 37 wherein the user indicates the portion of information by moving a pointer to the portion of information.

40. The method defined in claim 37 wherein the user indicates the portion of information by moving a highlight to the portion of information.

41. The method defined in claim 37 wherein the portion of information is an abbreviation, the method further comprising displaying the full form of the abbreviation in the interactive overlay.

42. The method defined in claim 37 wherein the portion of information is a given wager amount, the method further comprising displaying the estimated current payout of a wager placed for the given wager amount in the interactive overlay.

43. The method defined in claim 37 wherein the portion of information is a given wager amount, the method further comprising displaying the total wager amount in the interactive overlay.

44. The method defined in claim 37 wherein the portion of information is a horse number, the method further comprising displaying the horse name associated with the horse number in the interactive overlay.

45. The method defined in claim 37 wherein the portion of information is a horse number, the method further comprising displaying jockey and trainer information for the horse associated with the horse number in the interactive overlay.

46. The method defined in claim 37 wherein the portion of information is a horse number, the method further comprising displaying odds information for the horse associated with the horse number in the interactive overlay.

47. The method defined in claim 37 wherein the portion of information is a horse number, the method further comprising displaying the power rating of the horse associated with the horse number in the interactive overlay.

48. An interactive wagering system that provides information to the user, comprising user equipment configured to:
display information to the user;
allow the user to indicate a portion of the information; and
display an interactive overlay, in response to the user indicating the portion of information, that contains additional information associated with the portion of information.

49. The interactive wagering system defined in claim 48 further comprising user television equipment, wherein the user television equipment is the user equipment.

50. The interactive wagering system defined in claim 48 further comprising user computer equipment, wherein the user computer equipment is the user equipment.

51. The interactive wagering system defined in claim 48 further comprising user telephone equipment, wherein the user telephone equipment is the user equipment.

52. The interactive wagering system defined in claim 48 wherein the user equipment is further configured to remove the interactive overlay after the portion of information is no longer indicated by the user.

53. The interactive wagering system defined in claim 48 wherein the user equipment is further configured to allow the user to indicate the portion of information by moving a pointer to the portion of information.

54. The interactive wagering system defined in claim 48 wherein the user equipment is further configured to allow the user to indicate the portion of information by moving a highlight to the portion of information.

55. The interactive wagering system defined in claim 48 wherein the portion of information is an abbreviation and wherein the user equipment is further configured to display the full form of the abbreviation in the interactive overlay.

56. The interactive wagering system defined in claim 48 wherein the portion of information is a given wager amount and wherein the user equipment is further configured to display an estimated current payout of a wager placed for the given wager amount in the interactive overlay.

57. The interactive wagering system defined in claim 48 wherein the portion of information is a given wager amount and wherein the user equipment is further configured to display the total wager amount in the interactive overlay.

58. The interactive wagering system defined in claim 48 wherein the portion of information is a horse number and wherein the user equipment is further configured to display the horse name associated with the horse number in the interactive overlay.

59. The interactive wagering system defined in claim 48 wherein the portion of information is a horse number and wherein the user equipment is further configured to display the jockey and trainer information for the horse associated with the horse number in the interactive overlay.

60. The interactive wagering system defined in claim 48 wherein the portion of information is a horse number and wherein the user equipment is further configured to display odds information for the horse associated with the horse number in the interactive overlay.

61. The interactive wagering system defined in claim 48 wherein the portion of information is a horse number and wherein the user equipment is further configured to display the power rating of the horse associated with the horse number in the interactive overlay.
